(19) United States
(12) Patent Application Publication
(10) Pub. No.: US 2014/0218757 A1
(43) Pub. Date: Aug. 7, 2014

(54) IMAGE FORMING APPARATUS, IMAGE FORMING APPARATUS CONTROL METHOD, AND PROGRAM

(71) Applicant: CANON KABUSHIKI KAISHA, Tokyo (JP)

(72) Inventors: Yuichi Konosu, Tokyo (JP); Xiaoli Wang, Tokyo (JP); Takaaki Miyata, Tokyo (JP)

(21) Appl. No.: 14/168,994

(22) Filed: Jan. 30, 2014

(30) Foreign Application Priority Data
Feb. 1, 2013 (JP) 2013-018393

(51) Int. Cl. G06K 15/02

(52) U.S. Cl. CPC G06K 15/183
USPC 358/1.14

(57) ABSTRACT

In an image forming apparatus that includes a plurality of processing units configured to perform predetermined image processing and a connection unit configured to connect to an external storage unit, a CPU identifies, in response to the connection of an external storage unit, a read/write state of data in the external storage unit. The CPU specifies the processing units to supply power to among the plurality of processing units based on the identified read/write state, and supplies power to the specified processing units.

### BACKGROUND OF THE INVENTION

1. Field of the Invention

The present invention relates to an image forming apparatus, an image forming apparatus control method, and a program.

2. Description of the Related Art

Currently, in the workplace, there is a need for an image forming apparatus that has a high power-saving effect. Consequently, an image forming apparatus has been proposed that can reduce power consumption more effectively not only by turning the image forming apparatus on/off or employing a power saving mode for the whole image forming apparatus, but also by powering off units that are not used even during standby or while a job is being processed. Japanese Patent No. 3101592 discusses a method for turning an audio controller in a computer on/off, in which an audio device determines by itself the types of file that are stored in the device when the device is connected to a computer.

However, when a device like a universal serial bus (USB) storage is externally connected to an image forming apparatus in which a printer, a scanner and the like are mounted (i.e., a multifunction peripheral), the devices that are used in the apparatus are different depending on the job to be executed, such as scanning or printing. Further, when an external storage device like a USB storage or a secure digital (SD) card is connected to the image forming apparatus, the image forming apparatus needs to be placed in a state that is capable of executing the job.

In addition, the printer unit in a multifunction peripheral needs to increase the temperature of the fixing unit to a certain temperature in order to fix the toner to the paper. Therefore, the printer unit requires time until it is ready to print, and a large amount of power is consumed to raise the temperature of the fixing unit.

Further, other units in the image forming apparatus also require a large amount of power, for example the scanner has to emit light during scanning. Consequently, the power consumption of the image forming apparatus greatly fluctuates based on whether each of the units in the apparatus, such as the printer unit and the scanner unit, is powered on or not.

### SUMMARY OF THE INVENTION

The present invention is directed to a configuration capable of limiting the supply of power to processing units that are not used by identifying a connected external storage device and specifying the processing units that power should be supplied to.

According to an aspect of the present invention, an image forming apparatus includes a plurality of processing units configured to perform predetermined image processing, a connection unit configured to connect to an external storage unit, an identification unit configured to, in response to the connection of the external storage unit, identify information stored in the external storage unit, a specification unit configured to specify processing units to supply power to among the plurality of processing units based on the identified information, and a control unit configured to supply power to the specified processing units.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image forming apparatus.

FIG. 2A illustrates a powered-on state of the hardware devices in the image forming apparatus illustrated in FIG. 1.

FIG. 2B illustrates a powered-on state of the hardware devices in the image forming apparatus illustrated in FIG. 1.

FIG. 2C illustrates a powered-on state of the hardware devices in the image forming apparatus illustrated in FIG. 1.

FIG. 2D illustrates a powered-on state of the hardware devices in the image forming apparatus illustrated in FIG. 1.

FIG. 2E illustrates a powered-on state of the hardware devices in the image forming apparatus illustrated in FIG. 1.

FIG. 2F illustrates a powered-on state of the hardware in the image forming apparatus illustrated in FIG. 1.

FIG. 3 is a flowchart illustrating a method for controlling an image forming apparatus.

FIG. 4 is a flowchart illustrating a method for controlling an image forming apparatus.

FIG. 5 illustrates information for determining whether printing can be performed by an image forming apparatus.

FIG. 6 is a flowchart illustrating a method for controlling an image forming apparatus.

FIG. 7 illustrates control text data stored in an external storage device.

FIG. 8 is a flowchart illustrating a method for controlling an image forming apparatus.

FIG. 9 illustrates control text data stored in an external storage device.

FIG. 10 is a flowchart illustrating a method for controlling an image forming apparatus.

FIGS. 11A and 11B are flowcharts illustrating a method for controlling an image forming apparatus.

FIG. 12 is a flowchart illustrating a method for controlling an image forming apparatus.

FIG. 13 is a flowchart illustrating a method for controlling an image forming apparatus.

FIGS. 14A and 14B are flowcharts illustrating a method for controlling an image forming apparatus.

FIG. 15 is a flowchart illustrating a method for controlling an image forming apparatus.

### DESCRIPTION OF THE EMBODIMENTS

Various exemplary embodiments, features, and aspects of the invention will be described in detail below with reference to the drawings.

### Description of the System Configuration

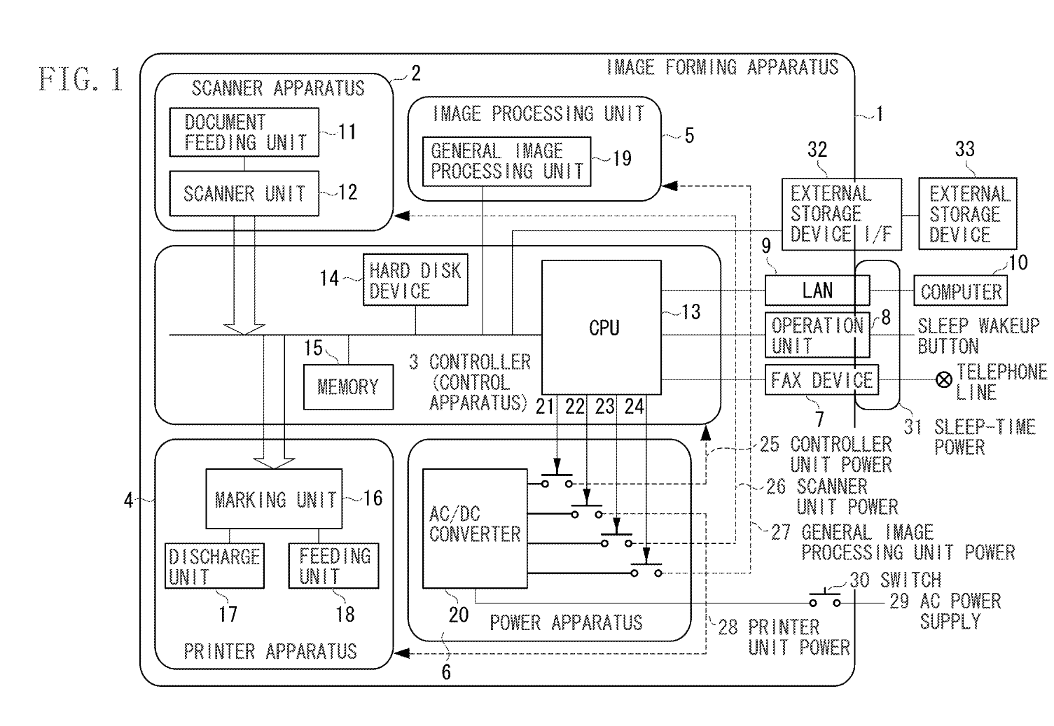

FIG. 1 is a block diagram illustrating a configuration of an image forming apparatus according to a first exemplary embodiment. In this example, an image forming apparatus 1 is configured from a multifunction peripheral that includes a scanner apparatus 2 and a printer apparatus 4. In the present exemplary embodiment, as a plurality of processing units, the image forming apparatus 1 includes the scanner apparatus 2, the printer apparatus 4, a controller 3, and an image processing unit 5. The relevant power supply performs corresponding processing by supplying power from a power apparatus 6. Further, in the present exemplary embodiment, a below-described external storage device 33 stores various kinds of data. Examples of these various kinds of data include print data, power supply instruction data, and control text data (Power.txt, described in detail below).

In FIG. 1, the scanner apparatus 2, which includes a contact image sensor (CIS), optically reads a document and converts the read document into a digital image. The printer apparatus 4 transfers a toner image developed on a photosensitive body onto a sheet, and then fixes a developer on the sheet using a thermal fixing unit.

An operation unit 8 is configured from an operation display screen, such as a liquid crystal touch panel, that is capable of displaying a setting state and a user operation, and operation buttons, such as a numeric keypad.

A hard disk drive (HDD) 14 stores digital images, control programs and the like. A facsimile (FAX) device 7 is connected to a telephone line, for example, and transmits and receives digital image data. The external storage device 33, which is configured from a USB storage or a SD card, for example, is connected to an internal bus of a central processing unit (CPU) 13 via an external storage apparatus interface (I/F) 32. Data is read from and written into the external storage device 33 by the CPU 13. The controller 3 (control device), which includes the CPU 13, executes jobs on the image forming apparatus by issuing instructions to each module. The image forming apparatus 1 is also configured so that digital images can be input/output, and jobs and device instructions can be issued, to/from a computer 10 via a local area network (LAN) 9.

The scanner apparatus 2 is configured from a document feeding unit 11 that can automatically sequentially switch document stacks, and a scanner unit 12 that can optically scan a document and convert the scanned document into a digital image. The converted image data is transmitted to the controller 3.

The printer apparatus 4 is configured from a feeding unit 18 that can sequentially feed single sheets from a paper stack, a marking unit 16 for printing image data on a fed sheet, and a discharge unit 17 for discharging sheets that have been printed. The controller 3, which includes the CPU 13, performs transmission, reception, and storage of image data with the scanner apparatus 2 and the printer apparatus 4. Namely, image data received by the controller 3 from the scanner apparatus 2 is temporarily stored in a memory 15.

Subsequently, the scanning and storage of the image is completed by storing the image data in the HDD 14. The controller 3 can output a print by temporarily storing the image data from the HDD 14 in the memory 15, and transmitting the image data from the memory 15 to the printer apparatus 4.

Further, the image processing unit 5, which includes a general image processing unit 19 that processes image data stored in the memory 15, can re-store in the memory 15 data that has been subjected to processing, such as reduction, by the general image processing unit 19. This general image processing unit 19 is used in various situations as necessary. The power apparatus 6 supplies power to the image forming apparatus 1. When the image forming apparatus 1 is OFF, an AC power supply 29 is isolated by a switch 30. AC power is supplied to an AC-DC converter by switching on the switch 30 to produce DC power. The image forming apparatus 1 according to the present exemplary embodiment can control the whole apparatus with four independent power supplies based on instructions from the CPU 13.

Namely, whether power from the controller unit power 25 is ON/OFF can be controlled by a switch unit 21 from the CPU 13. Similarly, a switch unit 22 performs control to switch ON/OFF a printer unit power 28, a switch unit 23 performs control to switch ON/OFF a scanner unit power 26, and a switch unit 24 performs control to switch ON/OFF a image processing unit power 27. The CPU 13 appropriately supplies power to the necessary places in the image forming apparatus 1 by using these switch units 21 to 24.

The image forming apparatus 1 according to the present exemplary embodiment includes the operation unit 8, which is controlled by the controller 3. The image forming apparatus 1 can execute various kinds of jobs by the CPU 13 interpreting operations made by the operator or instructions from the LAN 9. Examples of the executable function processes are illustrated below.

(Copying Function)

An image read from the scanner apparatus 2 is stored in the HDD 14, and printing is simultaneously performed using the printer apparatus 4.

(Image Transmission Function)

An image read from the scanner apparatus 2 is stored in the HDD 14, and transmitted to the computer 10 via the LAN 9.

(Image Storage Function)

An image read from the scanner apparatus 2 is stored in the HDD 14, and image transmission and image printing are performed as necessary.

(Image Printing Function)

Printing is performed by the printer apparatus 4 analyzing a page description language, for example, that transmitted from the computer 10.

(FAX Receipt and Print)

A FAX image received from the FAX device 7 is stored in the HDD 14, and simultaneously printed using the printer apparatus 4.

(FAX Transfer Processing)

A FAX image received from the FAX device 7 is stored in the HDD 14, and simultaneously transferred to the computer 10 via the LAN 9.

(FAX Memory Reception Processing)

A FAX image received from the FAX device 7 is stored in the HDD 14, and the image forming apparatus 1 waits for reference from the operator.

(FAX Transmission Processing)

An image read from the scanner apparatus 2 is stored in the HDD 14, and simultaneously transmitted from the FAX device 7 to a public line.

(External Storage Device Direct Printing)

An image stored in the external storage device 33, which is a USB storage, a SD card or the like, is stored in the HDD 14 via the external storage device I/F 32, and image printing is performed as necessary.

(External Storage Device Direct Storage Function)

An image read from the scanner apparatus 2 is stored in the HDD 14, and stored as necessary in the external storage device 33, which is a USB storage, a SD card or the like, via the external storage device I/F 32.

(External Storage Device Storage Function)

Data stored in the HDD 14 is stored in the external storage device 33 via the external storage device I/F 32. In many cases, the HDD 14 intervenes in the processes to deal with a job not executed properly or to recover from an abnormal state, such as the power cut off.

The power states that the image forming apparatus 1 can transition to will now be described.

(Sleep State)

This mode is a state in which the power of the image forming apparatus 1 per se is powered off as much as possible.

Specifically, the peripheral devices of the CPU are set to a typical suspend state (Advanced Configuration and Power Interface (ACPI)-S3 etc.), and only the portion capable of detecting a job (sleep time power 31) is powered on, so that the power of the overall apparatus can be in a very low power state.

Specifically, the CPU 13 stores the apparatus state in the memory 15, and powers off the controller unit power 25, which includes the CPU 13, with the switch unit 21. At this stage, although the CPU 13 itself stops operating, the CPU 13 can know that a job has come since the sleep time power 31 is turned on by hardware.

The controller unit power 25 is turned on by hardware when, for example, a job has been received from the LAN 9 via a network, a FAX call has been made from the FAX device 7, or an operation has been made on the operation unit 8 (e.g., pressing of a sleep wakeup button etc.).

The CPU 13 reads from the memory 15 the state of the apparatus stored in the memory 15, resets the apparatus, wakes up the apparatus into the state immediately before the controller unit power 25 was turned off, and transitions to a standby state.

Since the sleep state is a state in which many of the hardware units cannot operate, the only functions are those that cause a transition to a standby state. Jobs are received after the apparatus transitions to a standby state.

(Standby State)

This mode is a state in which the controller unit power 25 is turned on. Specifically, operations by the operator from the operation unit 8 and jobs via a network from the LAN 9 are received.

In this state, the liquid crystal backlight of an operation display screen in the operation unit 8 is extinguished. When the operator makes an operation (e.g., presses a sleep wakeup button etc.), the backlight is lit, and the operation display screen is turned on.

Since the printer unit power 28, the scanner unit power 26, and the general image processing unit power 27 are OFF, the CPU 13 switches on the power supplies of the devices using switch units 22 to 24, and then executes a predetermined job. For example, the power supply of each device is turned on in the following manner based on the type of job.

(Copying Function)

The scanner unit power 26 and the printer unit power 28 are turned on, and the copying function is realized in the manner described above.

(Image Transmission Function)

Just the scanner unit power 26 is turned on, and the read image data is transmitted.

(Image Storage Function)

Just the scanner unit power 26 is turned on, and the read image data is stored.

(Image Printing Function)

Just the printer unit power 28 is turned on, and various image data is printed.

(FAX Receipt and Print)

The printer unit power 28 and the general image processing unit power 27 are turned on, the received FAX image is subjected to general image processing, and then printed.

(FAX Transmission Processing)

Just the general image processing unit power 27 is turned on, data received via FAX is subjected to general image processing, and then printed.

(FAX Memory Reception Processing)

Just the general image processing unit power 27 is turned on, data received via FAX is subjected to general image processing, and then stored in the HDD 14.

(FAX Transmission Processing)

The scanner unit power 26 and the general image processing unit power 27 are turned on, and the read FAX image data is transmitted to a public line.

(External Storage Device Direct Printing)

When the external storage device 33, which is a USB storage, a SD card or the like, is connected, the printer unit power 28 is turned on and various image data is printed.

(External Storage Device Direct Storage Function)

When the external storage device 33, which is a USB storage, a SD card or the like, is connected, the scanner unit power 26 is turned on, and the read image data is stored in the external storage device 33 via the external storage device I/F 32.

(External Storage Device Storage Function)

When the external storage device 33, which is a USB storage, a SD card or the like, is connected, a predetermined piece of data stored in the HDD 14 is stored in the external storage device 33 via the external storage device I/F 32. Note that the general image processing unit power 27 may be turned on for any type of job.

By powering off a device after a job is completed, it becomes possible to power on the devices only when required (i.e., while they are being used), so that the amount of power used during standby can be reduced.

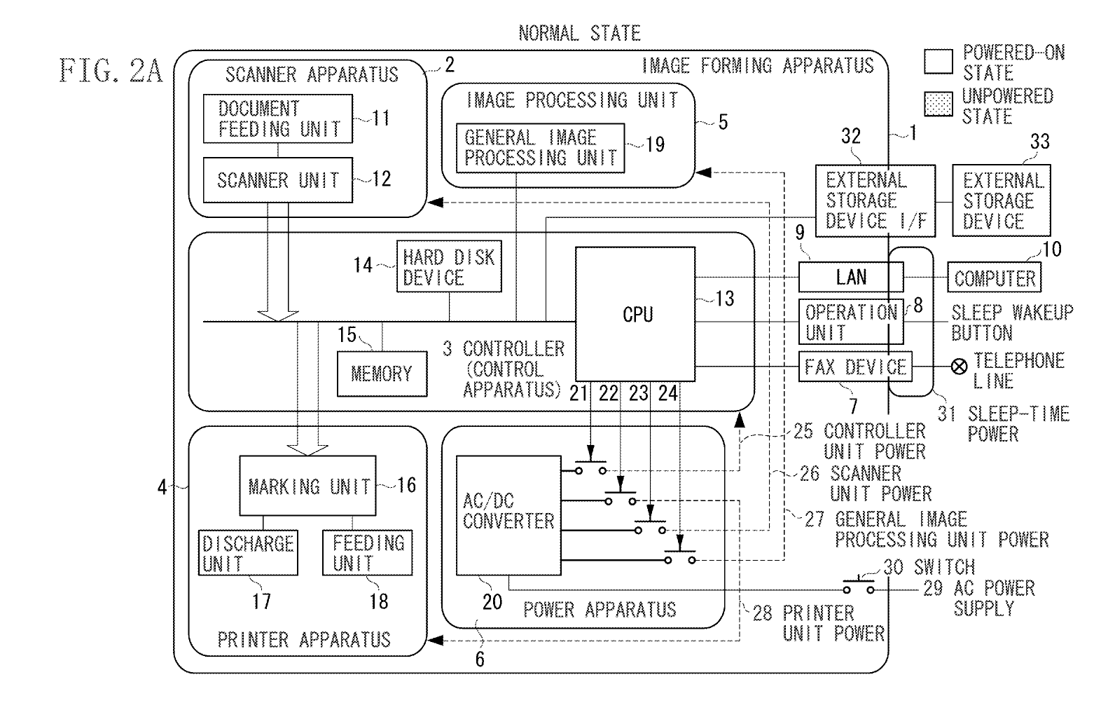

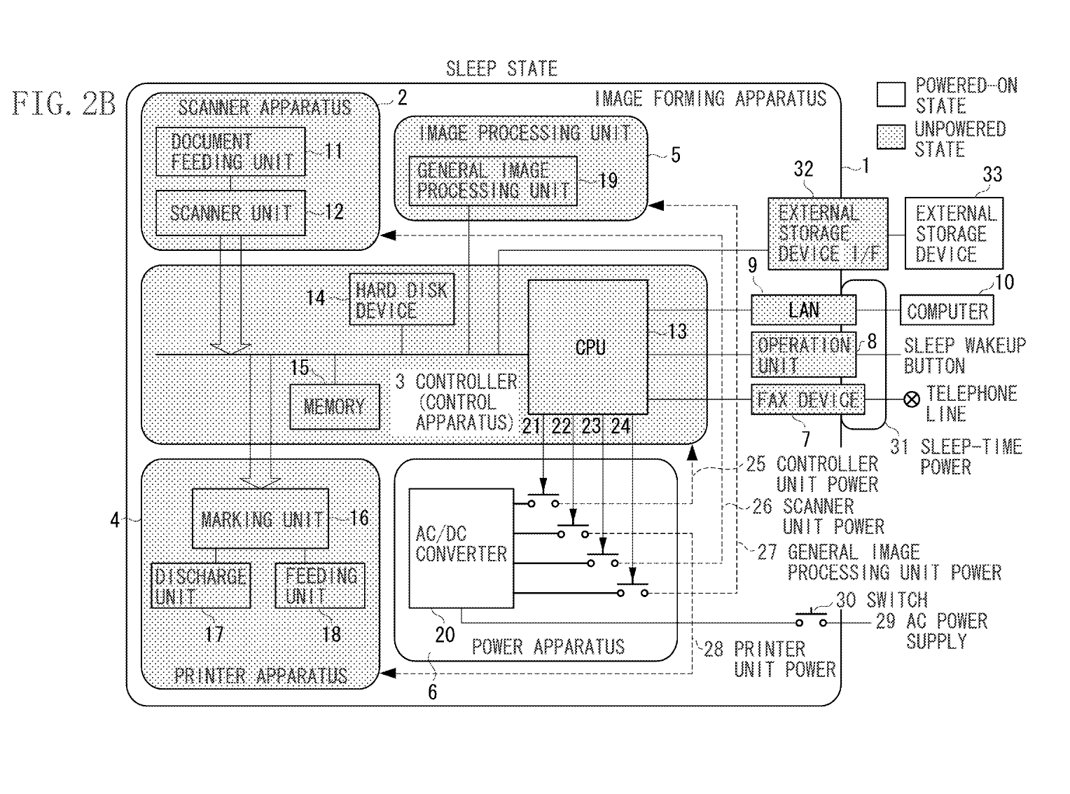

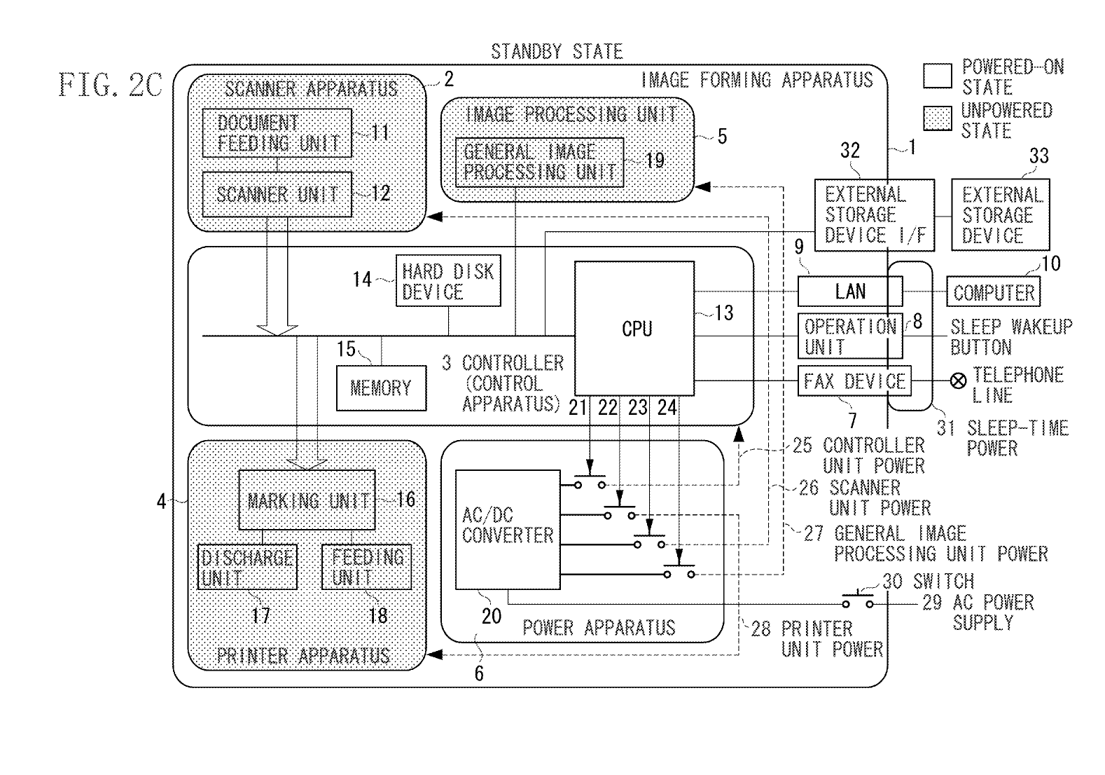

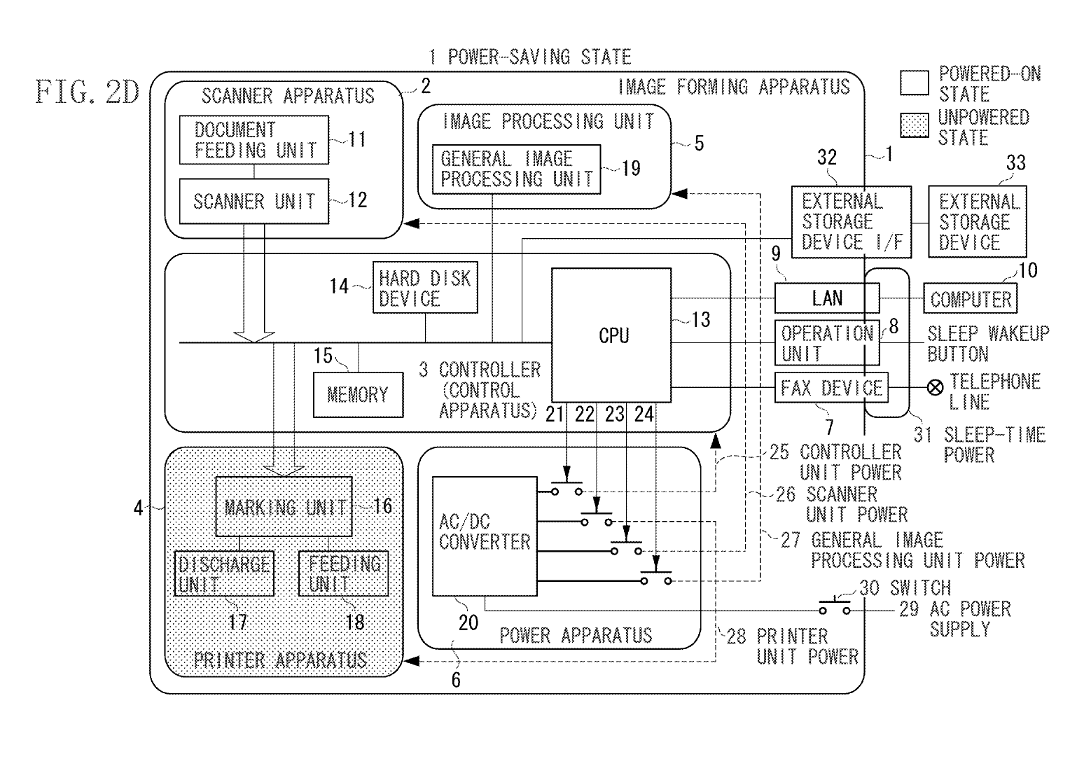

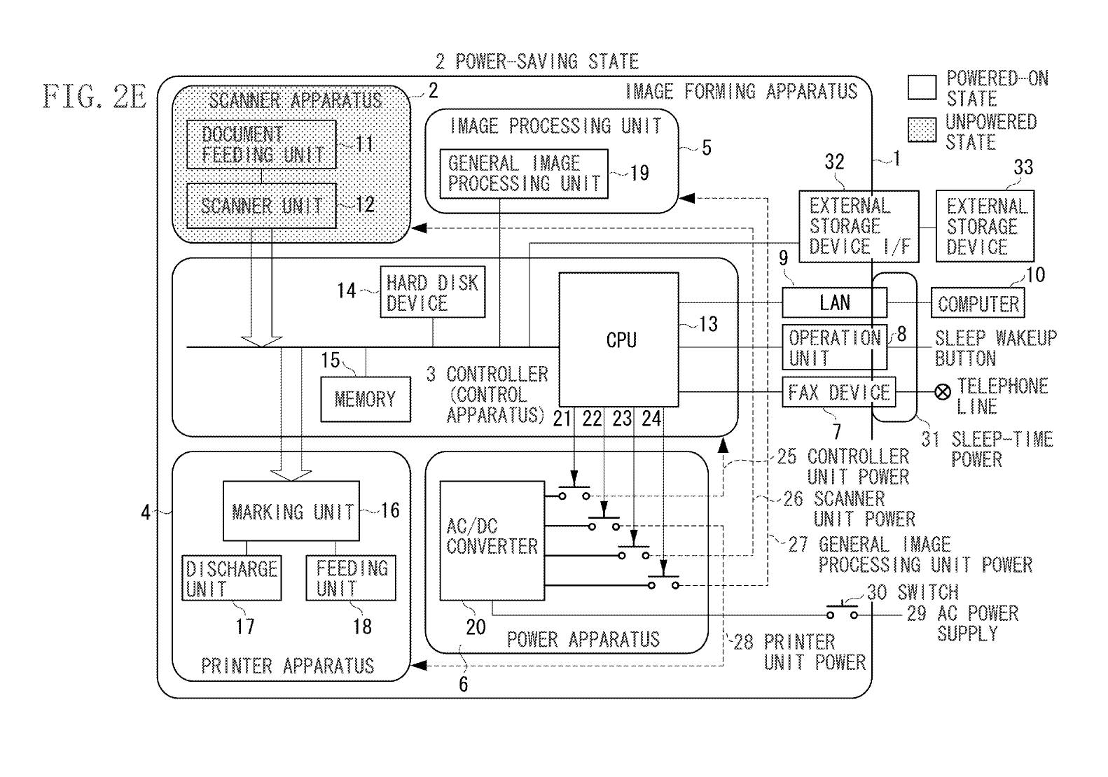

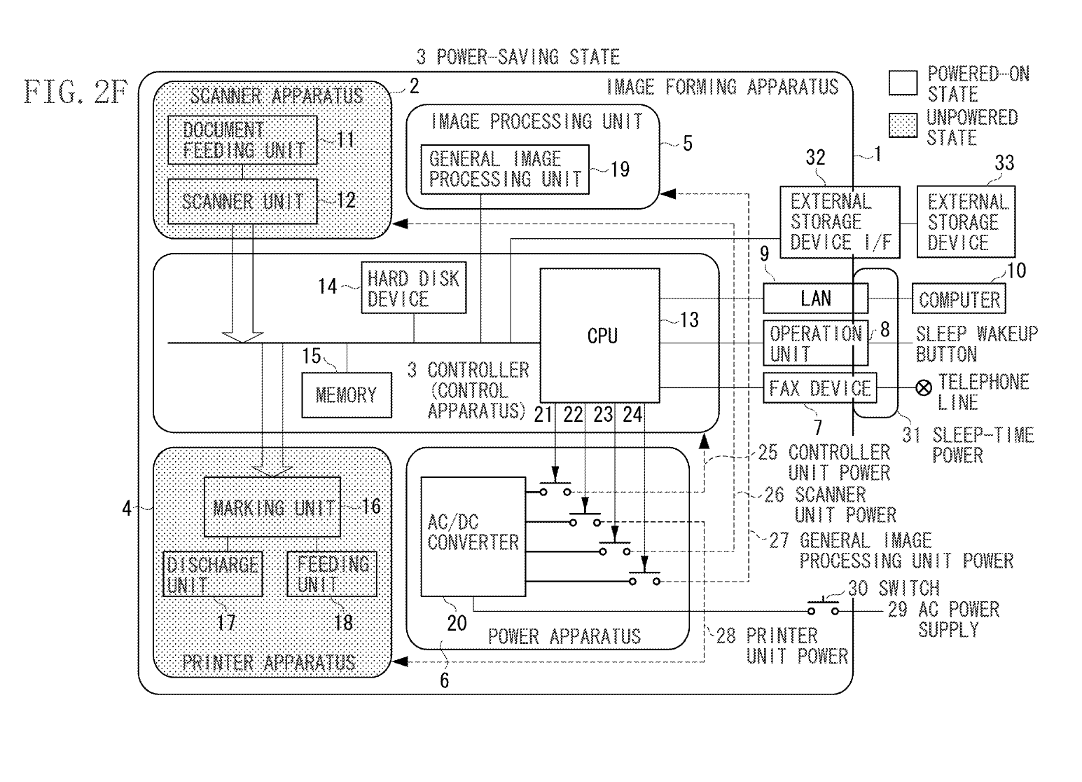

FIGS. 2A to 2F illustrate a powered-on state of the hardware devices in the image forming apparatus 1 illustrated in FIG. 1.

FIG. 2A corresponds to a normal state in which the controller unit power 25, the scanner unit power 26, the general image processing unit power 27, and the printer unit power 28 are powered on. For example, it is a state of power when a copying machine function is in use.

FIG. 2B corresponds to a sleep state in which, as described above, the power of the image forming apparatus 1 per se is turned off as much as possible. In this state, power 25 to 28 to the respective units is turned off. Further, since the controller 3 and the external storage device I/F 32 are not powered on, even if the external storage device 33 is connected, the CPU 13 cannot recognize the external storage device 33.

FIG. 2C corresponds to a standby state in which, as described above, the controller unit power 25 is turned on. In this state, the scanner unit power 26, the general image processing unit power 27, and the printer unit power 28 are not turned on. Further, since the controller 3 and the external storage device I/F 32 are powered on, if the external storage device 33 is connected, the CPU 13 can recognize the external storage device 33.

FIG. 2D corresponds to a first power saving state in which the controller unit power 25, the scanner unit power 26, and the general image processing unit power 27 are turned on. In this state, the printer unit power 28 is not turned on. Further, the first power saving state corresponds to the power state during usage of the image transmission function/the image storage function/FAX transmission processing/and the external storage device direct storage function.

FIG. 2E corresponds to a second power saving state in which the controller unit power 25, the general image processing unit power 27, and the printer unit power 28 are turned on. In this state, the scanner unit power 26 is not turned on. Further, the second power saving state corresponds to the power state in which the image printing function/FAX receipt and printing/and external storage device direct printing is carried out.

FIG. 2F corresponds to a third power saving state in which the controller unit power 25 and the general image processing unit power 27 are turned on. In this state, the printer unit power 28 and the scanner unit power 26 are not turned on. Further, the third power saving state corresponds to the power state in which FAX transmission processing/FAX memory reception processing/and the external storage function are carried out. However, in each power state, power is supplied by the AC power supply 29 to the AC-DC converter 20 that supplies power to the respective apparatuses and units.

Further, when the image forming apparatus 1 is in the standby state illustrated in FIG. 2C, although the operation unit 8 is powered on, to reduce power the operation display screen is extinguished or stopped. When the state has transitioned from the standby state illustrated in FIG. 2C to the normal state illustrated in FIG. 2A, the first power saving state illustrated in FIG. 2D, or the second power saving state illustrated in FIG. 2E, the operation display screen of the 8 is turned on so that it enters an activatable or operable state.

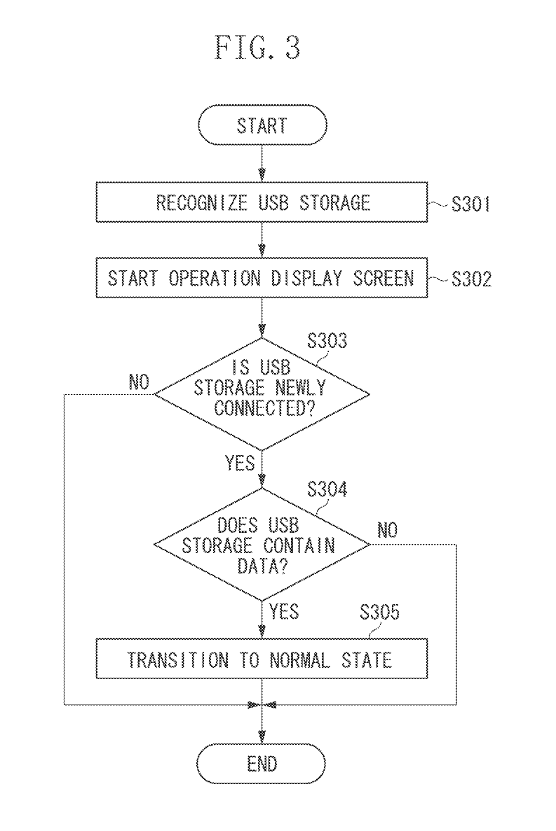

FIG. 3 is a flowchart illustrating a method for controlling the image forming apparatus according to the present exemplary embodiment. This is an example of power control executed upon recognition that the external storage device 33 has been connected to the external storage device I/F 32 illustrated in FIG. 1. Each step is realized by the CPU 13 executing a control program stored in the HDD 14.

In the following description, it is assumed that a USB storage is used as an example of the external storage device 33. As described above, since the USB storage cannot be recognized in the sleep state illustrated in FIG. 2B, the power state of the image forming apparatus 1 at the start of the flowchart is the standby state illustrated in FIG. 2C.

When the power state of the image forming apparatus 1 is in the standby state illustrated in FIG. 2C, in step S301, the CPU 13 recognizes that a USB storage is connected via the external storage device I/F 32, and the processing proceeds to step S302. In step S302, the CPU 13 turns on the operation display screen of the operation unit 8 so that the image forming apparatus 1 can be operated by the user, and the processing then proceeds to step S303.

In step S303, the CPU 13 determines whether the connected USB storage was newly connected in the standby state of the image forming apparatus 1 illustrated in FIG. 2C. If it is determined that the USB storage was newly connected, a connect signal is input to the CPU 13.

Consequently, if a connect signal is input to the CPU 13, the CPU 13 can determine that the USB storage is newly connected, and if a connect signal is not input, the CPU 13 can determine that there has been no change (i.e., the USB storage is not newly connected) to the connection state, that is, an already-connected USB storage is still connected.

If it is determined that the USB storage is newly connected (YES in step S303), the processing proceeds to step S304. If it is determined that the USB storage is not newly connected (NO in step S303), the CPU 13 does not perform processing such as power-on.

In step S304, the CPU 13 performs data detection processing on the USB storage via the external storage device I/F 32. If the CPU 13 detects data in the USB storage (YES in step S304), the processing proceeds to step S305. If the CPU 13 cannot detect data in the USB storage (NO in step S304), the CPU 13 does not perform processing such as power-on.

In step S305, the CPU 13 turns on the scanner unit power 26, the general image processing unit power 27, and the printer unit power 28, and the power state of the image forming apparatus 1 transitions to the normal state illustrated in FIG. 2A. If it is determined by the CPU 13 in step S304 that the CPU 13 cannot detect data in the USB storage, it may be considered that the user is going to store scanned data in the USB storage. In this case, the CPU 13 may perform control so that in step S305 the power state of the image forming apparatus 1 transitions to the first power saving state illustrated in FIG. 2D by powering on the specified scanner unit power 26 and general image processing unit power 27.

For example, when the user connects a USB storage to the external storage device I/F 32 of the image forming apparatus 1, if there is no data in the USB storage, printing from the USB storage cannot be executed. Consequently, in the present exemplary embodiment, since the printer apparatus 4 is not powered on, power consumption can be suppressed.

Further, if there is data in the USB storage, there is a chance that user may perform printing from the USB storage. Consequently, if there is data in the USB storage, since the printer apparatus 4 is powered on, the temperature of the fixing unit in the printer apparatus 4 can be raised in advance, so that the print job can be executed efficiently.

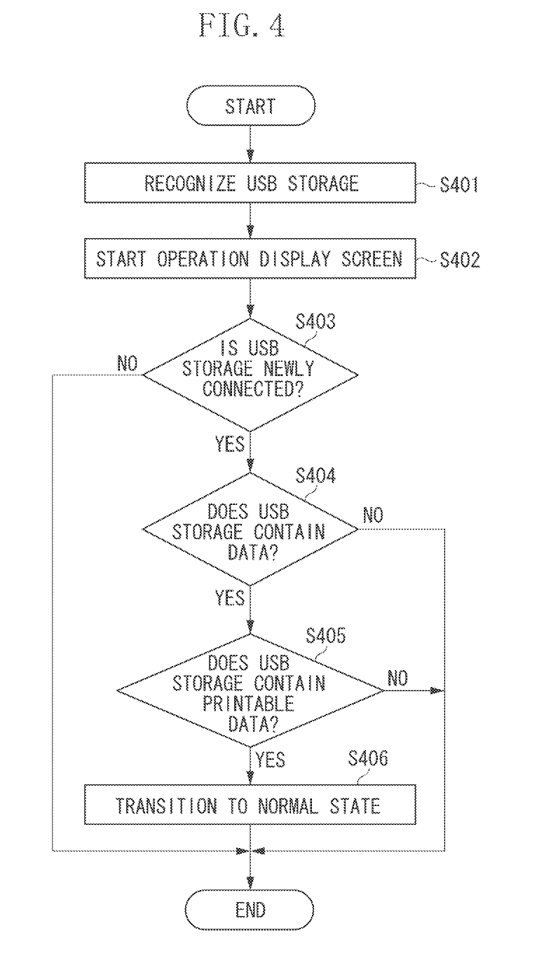

FIG. 4 is a flowchart illustrating a method for controlling the image forming apparatus according to a second exemplary embodiment. This is an example of power control executed upon recognition that the external storage device 33 has been connected to the external storage device I/F 32 illustrated in FIG. 1. Each step is realized by the CPU 13 executing a control program stored in the HDD 14.

In the present exemplary embodiment, similar to the first exemplary embodiment, a case is described in which the external storage device 33 is a USB storage. As described above, since the USB storage cannot be recognized in the sleep state illustrated in FIG. 2B, the power state of the image forming apparatus 1 at the start of the flowchart is the standby state illustrated in FIG. 2C.

When the power state of the image forming apparatus 1 is in the standby state illustrated in FIG. 2C, in step S401, the CPU 13 recognizes that a USB storage is connected via the external storage device I/F 32, and the processing proceeds to step S402.

In step S402, the CPU 13 turns on the operation display screen of the operation unit 8 so that the image forming apparatus 1 can be operated by the user, and the processing then proceeds to step S403. In step S403, the CPU 13 determines whether the connected USB storage was newly connected during the standby of the image forming apparatus 1 illustrated in FIG. 2C. If it is determined by the CPU 13 that the USB storage was newly connected, a connect signal is input to the CPU 13.

Consequently, if it is determined that a connect signal has been input, the CPU 13 can determine that the USB storage is newly connected. If it is determined that a connect signal has not been input, the CPU 13 can determine that the connection state has not changed (i.e., the USB storage is not newly connected).

If it is determined that the USB storage is newly connected (YES in step S403), the processing proceeds to step S404. If it is determined that the USB storage is not newly connected (NO in step S403), the CPU 13 finishes this processing without performing power-on and the like.

In step S404, the CPU 13 performs data detection processing on the USB storage via the external storage device I/F 32. If the CPU 13 determines that data is detected in the USB storage (YES in step S404), the processing proceeds to step S405. If the CPU 13 determines that data cannot be detected in the USB storage (NO in step S404), the CPU 13 finishes this processing without performing power-on and the like.

In step S405, the CPU 13 detects the type of data within the USB storage via the external storage device I/F 32.

In this step, the CPU 13 determines whether it has detected data within the USB storage that can be printed by the image forming apparatus 1. If it is determined by the CPU 13 that it has detected data that can be printed by the image forming apparatus 1 (YES in step S405), the processing proceeds to step S406. If it is determined by the CPU 13 that data cannot be detected that can be printed (NO in step S405), the CPU 13 finishes this processing without performing power-on and the like.

In step S406, the CPU 13 turns on the scanner unit power 26, the general image processing unit power 27, and the printer unit power 28, and performs control so that the power state of the image forming apparatus 1 transitions to the normal state illustrated in FIG. 2A.

If it is determined in step S404 that the CPU 13 cannot detect data in the USB storage, or in step S405 that the CPU 13 cannot detect printable data, it may be considered that the user is going to store scanned data in the USB storage. In this case, in step S406, the CPU 13 may perform control so that the power state of the image forming apparatus 1 transitions to the first power saving state illustrated in FIG. 2D by powering on the specified scanner unit power 26 and general image processing unit power 27.

For example, when the user connects a USB storage to the external storage device I/F 32 of the image forming apparatus 1, if there is no data that can be printed by the image forming apparatus 1 within the USB storage, printing from the USB storage cannot be executed. Consequently, in the second exemplary embodiment, since the printer apparatus 4 is not powered on, power consumption can be suppressed.

Further, if there is printable data within the USB storage, the user can execute printing from the USB storage. Consequently, if there is printable data, since the printer apparatus 4 is powered on, the temperature of the fixing unit in the printer apparatus 4 can be raised in advance, so that the print job can be executed efficiently. In addition, the determination whether the data in the USB storage is printable can be made by the image forming apparatus 1 referring to an extension file or a magic number of the data, for example.

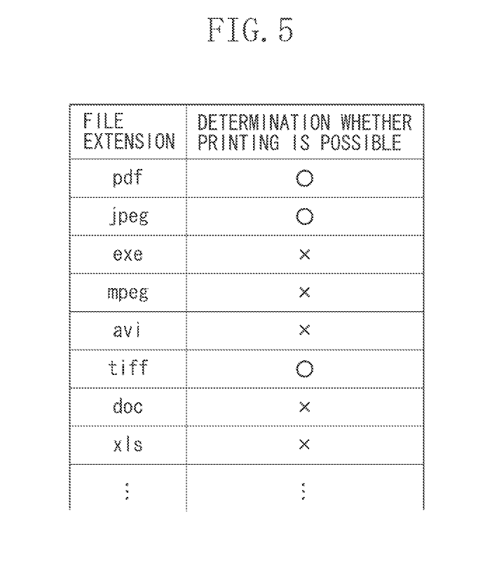

FIG. 5 illustrates information for determining whether printing can be performed by the image forming apparatus according to the present exemplary embodiment. In this example, the determination of whether data in the USB storage can be printed is made based on the extension file of the data.

In FIG. 5, for example, pdf/jpeg/tiff are image data. Since the image forming apparatus 1 includes a unit for analyzing such data, it is determined that data having these extensions files is printable. Since the image forming apparatus 1 does not include a unit for analyzing doc (Word)/xls (Excel) data, it is determined that these extensions files are not printable. Further, since exe (execution file) is not image data, and mpeg and avi are moving image data, data having these extension files is not a printing target, and thus it is determined that these data is not printable.

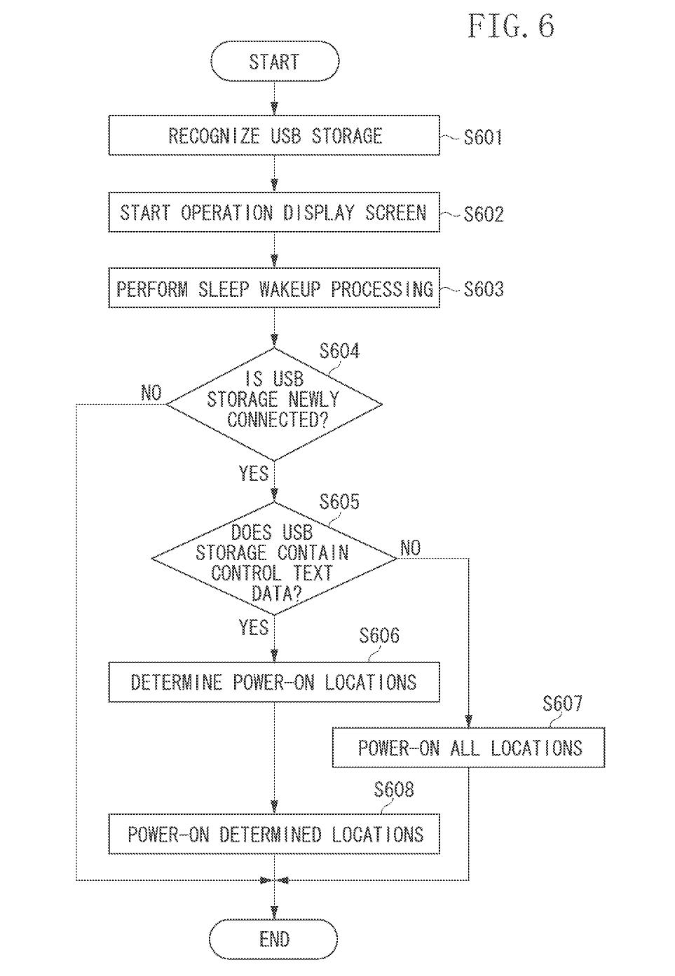

FIG. 6 is a flowchart illustrating a method for controlling the image forming apparatus according to a third exemplary embodiment. This is an example of power control executed upon recognition that the external storage device 33 has been connected to the external storage device I/F 32 illustrated in FIG. 1. Each step is realized by the CPU 13 executing a control program stored in the HDD 14.

In the present exemplary embodiment, similar to the first exemplary embodiment, a case is described in which the external storage device 33 is a USB storage. As described above, in the sleep state illustrated in FIG. 2B, the USB storage cannot be recognized. Therefore, the power state of the image forming apparatus 1 at the start of the flowchart is the standby state illustrated in FIG. 2C.

When the power state of the image forming apparatus 1 is in the standby state illustrated in FIG. 2C, in step S601, the CPU 13 recognizes that a USB storage is connected via the external storage device I/F 32, and the processing proceeds to step S602. In step S602, the CPU 13 turns on the operation display screen of the operation unit 8 so that the image forming apparatus 1 can be operated by the user, and the processing then proceeds to step S603.

In step S603, the image forming apparatus 1 executes internal processing for waking up from the sleep state, and the processing proceeds to step S604.

In step S604, the CPU 13 determines whether the connected USB storage was newly connected during the standby of the image forming apparatus 1 illustrated in FIG. 2C. If it is determined by the CPU 13 that the USB storage was newly connected, a connect signal is input to the CPU 13 from the external storage device I/F 32.

Consequently, if a connect signal has been issued from the external storage device I/F 32, the CPU 13 can determine that the USB storage is newly connected. If a connect signal has not been issued from the external storage device I/F 32, the CPU 13 can determine that the connection state has not changed (i.e., the USB storage is not newly connected).

If it is determined by the CPU 13 that the USB storage is newly connected (YES in step S604), the processing proceeds to step S605. If it is determined by the CPU 13 that the USB storage is not newly connected (NO in step S604), the CPU 13 finishes this processing without performing power-on and the like.

In step S605, the CPU 13 determines via the external storage device I/F 32 whether control text data has been detected in the USB storage.

If it is determined that the CPU 13 detected control text data (Power.txt) in the USB storage (YES in step S605), the processing proceeds to step S606. If it is determined by the CPU 13 that it cannot detect such data (NO in step S605), the processing proceeds to step S607. In step S607, since the image forming apparatus 1 powers on all units, the power state enters the normal state illustrated in FIG. 2A.

In step S606, the CPU 13 analyzes the content of the Power.txt, and determines the units to be powered on. In the present exemplary embodiment, the units that can be turned on are the scanner unit power 26, the general image processing unit power 27, and the printer unit power 28. Then, the processing proceeds to step S608.

In step S608, the CPU 13 controls the switches illustrated in FIG. 1 so that power-on locations determined in step S606 are powered on. As described above, if it is determined by the CPU 13 that there is no control text data (Power.txt), all functions (scanner unit power 26, general image processing unit power 27, and printer unit power 28) are powered on, and the processing performed in this flowchart is finished. In step S607, since the image forming apparatus 1 powers on all units, the power state enters the normal state illustrated in FIG. 2A.

For example, if the user has stored a Power.txt (printer ON, all other functions OFF) in a printing-dedicated USB storage, when the USB storage is connected to the external storage device I/F 32 of the image forming apparatus 1, the CPU 13 analyzes the text data and determines that only the printer apparatus 4 should be powered on, which allows power consumption to be suppressed. Consequently, if there is data in the USB storage, the printer apparatus 4 is powered on, so that the temperature of the fixing unit in the printer apparatus 4 can be raised in advance, enabling the print job to be executed efficiently.

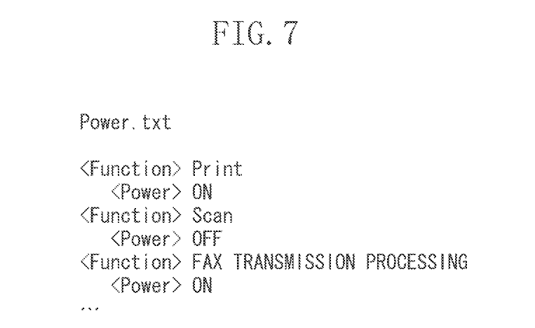

FIG. 7 illustrates an example of control text data stored in the external storage device 33 illustrated in FIG. 1. In this example, the functions of printer, scan, and FAX transmission processing, and the powered-on state of those functions, are described in the control text data.

The image forming apparatus 1 refers to this control text data, and based on that, the CPU 13 executes control to transition the power state of the image forming apparatus 1 to the second power saving state illustrated in FIG. 2E by powering on the general image processing unit power 27 and the printer unit power 28 but not the scanner unit power 26.

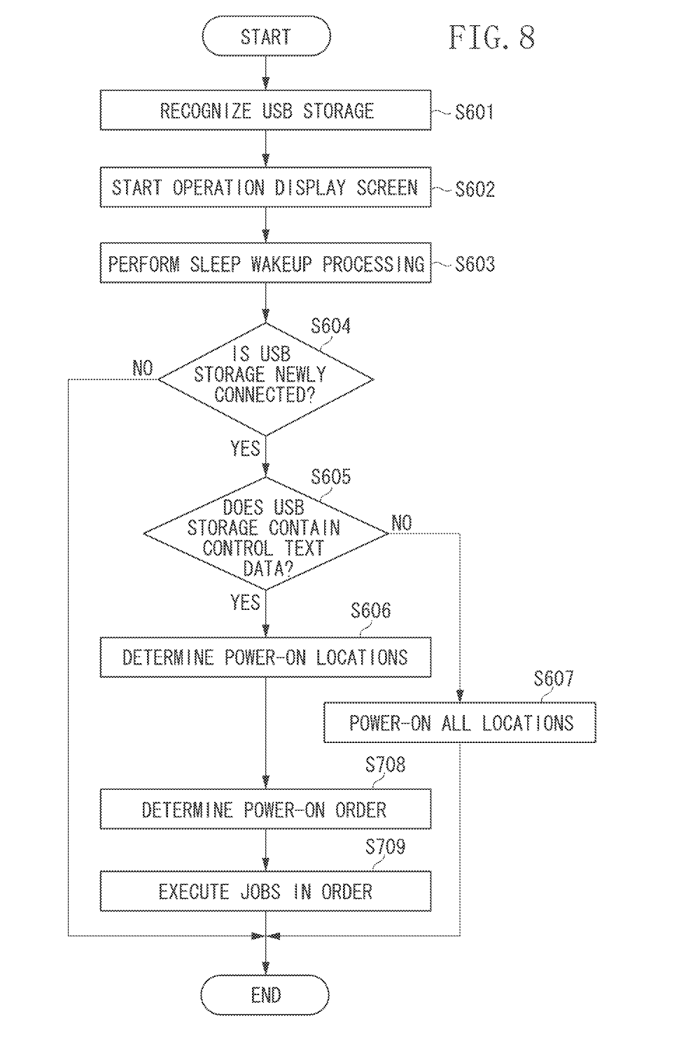

FIG. 8 is a flowchart illustrating a method for controlling the image forming apparatus according to a fourth exemplary embodiment. This is an example of power control executed upon recognition that the external storage device 33 has been connected to the external storage device I/F 32 illustrated in FIG. 1. Each step is realized by the CPU 13 executing a control program stored in the HDD 14.

In the present exemplary embodiment, similar to the first exemplary embodiment, a case is described in which the external storage device 33 is a USB storage. As described above, in the sleep state illustrated in FIG. 2B, the USB storage cannot be recognized. Therefore, the power state of the image forming apparatus 1 at the start of the flowchart is the standby state illustrated in FIG. 2C. Since steps S601 to S607 have already been described with reference to FIG. 6, a description of these steps will be omitted here.

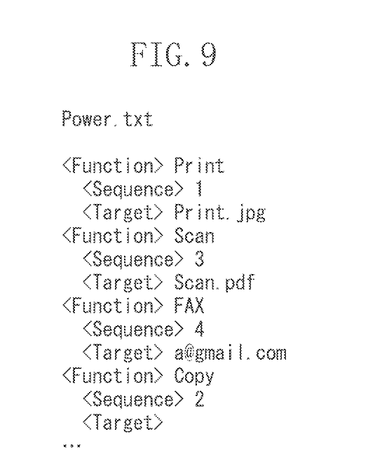

In step S708, the CPU 13 analyzes the contents of the Power.txt read from the USB storage, and determines the power-on order according to the job to be performed based on the control text data illustrated in FIG. 9. Then, the processing proceeds to step S709.

In step S709, the CPU 13 powers on the units as specified in Power.txt. Jobs that can be partially automatically performed (e.g., printing of documents and images) are performed automatically, which helps alleviate the work performed by the user. Further, by powering off unnecessary units, power consumption can be suppressed.

As described above, if there is no control text data (Power.txt), all of the functions (scanner unit power 26, general image processing unit power 27, and printer unit power 28) are powered on. Consequently, the user can utilize the image forming apparatus 1 under any situation.

FIG. 9 is an example of the control text data which is stored in the external storage device 33 illustrated in FIG. 1. In this example, the functions of printer, scan, and fax transmission processing as well as their power-on order and execution target are described in the control text data. The image forming apparatus 1 may refer to this data and sequentially powers on the functions to automatically execute a part of jobs.

In the example illustrated in FIG. 9, power state is executed in the following order. In the control text data, the execution order is stored as print→copy→scan→process→dispatch. Accordingly, the CPU 13 performs control so that the power state of the image forming apparatus 1 transitions as follows. Second power saving state illustrated in FIG. 2E→normal state illustrated in FIG. 2A→first power saving state illustrated in FIG. 2D→third power saving state illustrated in FIG. 2F. Consequently, among the hardware devices illustrated in FIG. 1, the units to be powered on transition as follows.

In the second power saving state illustrated in FIG. 2E, the general image processing unit power 27 and the printer unit power 28 are powered on. In the normal state illustrated in FIG. 2A, the general image processing unit power 27, the printer unit power 28, and the scanner unit power 26 are turned on. In the first power saving state illustrated in FIG. 2D, the general image processing unit power 27 and the scanner unit power 26 are turned on, and in the third power saving state illustrated in FIG. 2F, the general image processing unit power 27 is turned on.

Among these sequences, since the printing and processing targets are specified, the image forming apparatus automatically executes printing processing, and outputs a file (Print.jpg) specified by the text data stored in the external storage device. Further, in the fourth sequence, the processing result can be automatically transmitted to a specified e-mail address (a@gmail.com). However, in the case of the third sequence (scan) and the second sequence (copy), since the user needs to enter the number of copies into the image forming apparatus, these sequences cannot be automatically executed.

Thus, since the user needs to enter the number of copies into the image forming apparatus for the third sequence (scan) and the second sequence (copy), a reduction in power consumption can be realized by powering on as necessary. Further, since some of the jobs stored in the external storage device can be executed without the user doing anything, jobs can be finished rapidly. Consequently, power consumption can be reduced even further by reducing the powered-on time.

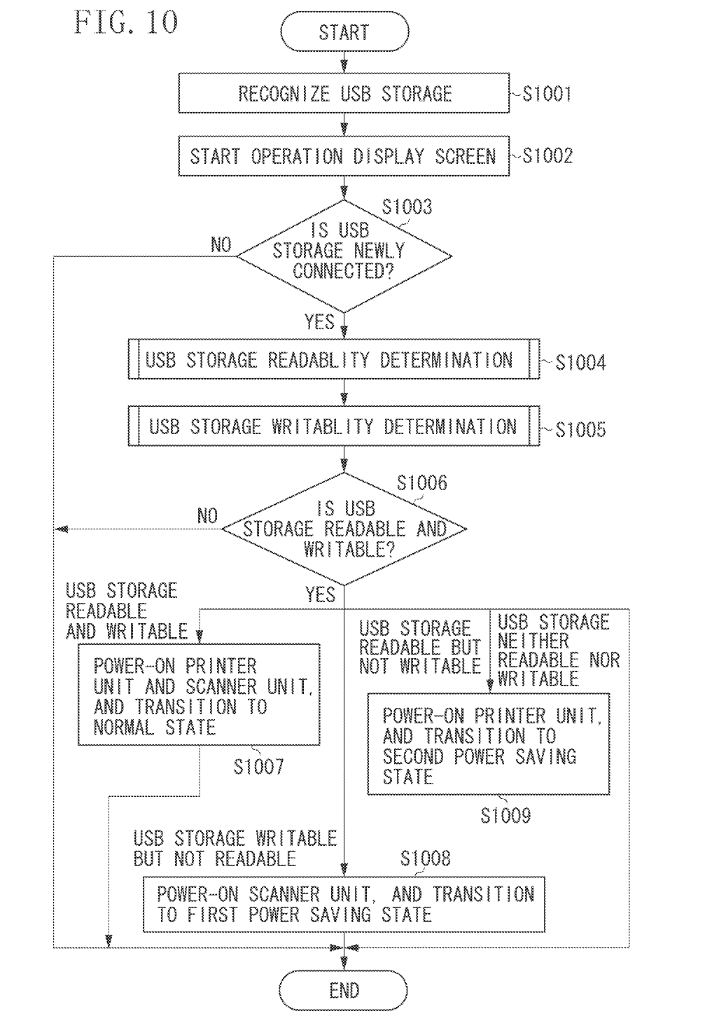

FIG. 10 is a flowchart illustrating a method for controlling the image forming apparatus according to a fifth exemplary embodiment. This is an example of a power control executed upon recognition that the external storage device 33 has been connected to the external storage device I/F 32 illustrated in FIG. 1. Each step is realized by the CPU 13 executing a control program stored in the HDD 14.

In the present exemplary embodiment, similar to the first exemplary embodiment, a case is described in which the external storage device 33 is a USB storage. As described above, in the sleep state illustrated in FIG. 2B, the USB storage cannot be recognized. Therefore, the power state of the image forming apparatus 1 at the start of the flowchart is the standby state illustrated in FIG. 2C.

When the power state of the image forming apparatus 1 is in the standby state illustrated in FIG. 2C, in step S1001, the CPU 13 recognizes that a USB storage is connected via the external storage device I/F 32, and the processing proceeds to step S1002. In step S1002, the CPU 13 turns on the operation display screen of the operation unit 8 so that the image forming apparatus 1 can be operated by the user, and the processing then proceeds to step S1003. In step S1003, the CPU 13 determines whether the connected USB storage was newly connected during the standby of the image forming apparatus 1 illustrated in FIG. 2C. If it is determined by the CPU 13 that the USB storage was newly connected, a connect signal is input to the CPU 13 from the external storage device I/F 32.

Consequently, if a connect signal has been input to the CPU 13, the CPU 13 can determine that the USB storage is newly connected. If it is determined that a connect signal has not been input, the CPU 13 can determine that the connection state has not changed (i.e., the USB storage is not newly connected). If it is determined that the USB storage is newly connected (YES in step S1003), the processing proceeds to step S1004, and if it is determined that the USB storage is not newly connected (NO in step S1003), the CPU 13 finishes this processing without performing power-on and the like.

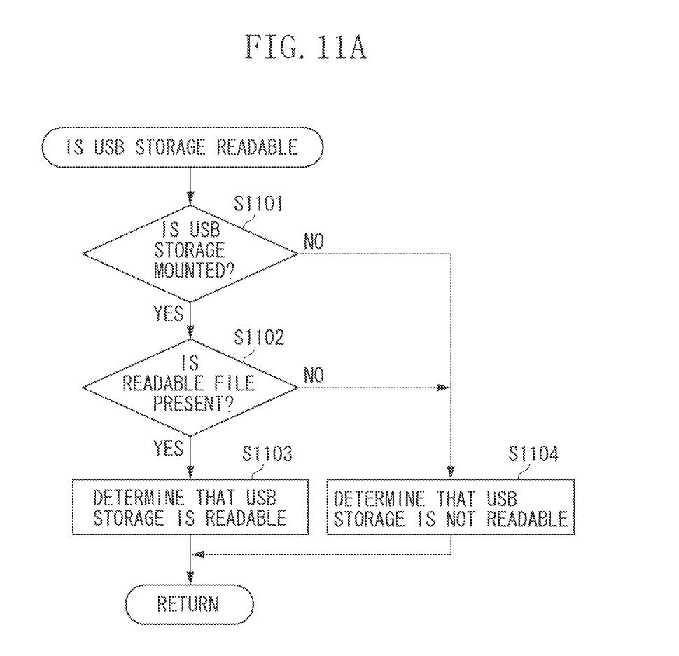

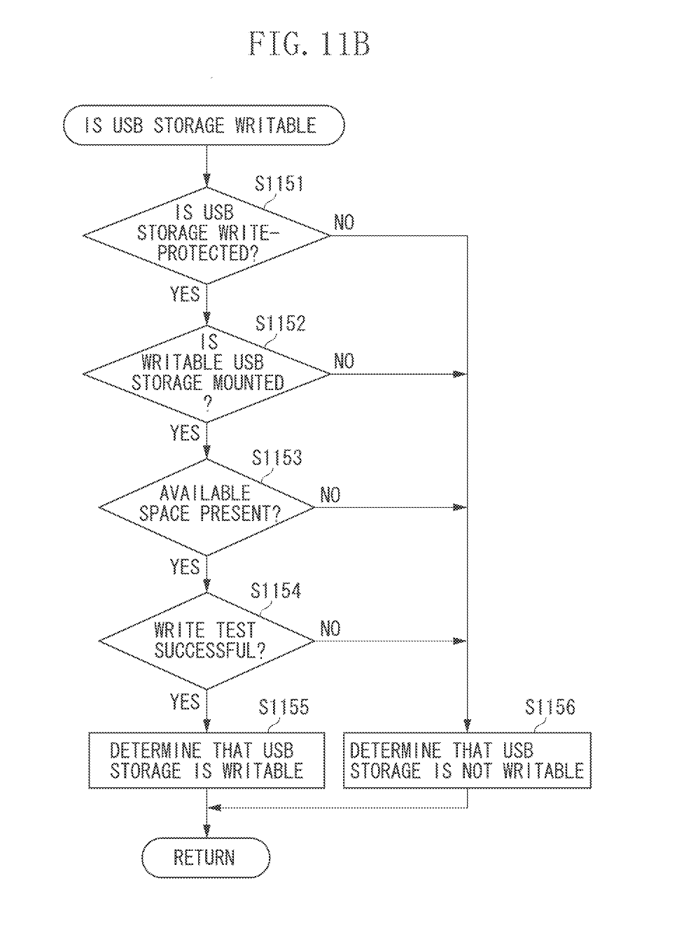

In step S1004, the CPU 13 determines whether the USB storage is readable. The details of step S1004 will be described with reference to FIG. 11A.

In step S1005, the CPU 13 determines whether the USB storage is writable. The details of step S1005 will be described with reference to FIG. 11B.

In step S1006, the CPU 13 executes control for transitioning the power state as described below based on the results of the determinations performed in steps S1004 and S1005.

Namely, if it is determined that the USB storage is readable and writable, the processing proceeds to step S1007. In step S1007, the CPU 13 performs control to transition the power state of the image forming apparatus 1 to the normal state illustrated in FIG. 2A by powering on the scanner unit power 26, the general image processing unit power 27, and the printer unit power 28. Then, the processing performed in this flowchart is finished.

If it is determined that the USB storage is writable but not readable, the processing proceeds to step S1008. In step S1008, the CPU 13 performs control to transition the power state of the image forming apparatus 1 to the first power saving state illustrated in FIG. 2D by powering on the scanner unit power 26 and the general image processing unit power 27 based on a specified read/write state, and then finishes the processing. This is because since the USB storage is not readable, printing cannot be performed by reading a file in the USB storage, so that the likelihood of the print function usage is low.

Further, if it is determined that the USB storage is readable but not writable, the processing proceeds to step S1009. In step S1009, the CPU 13 performs control to transition the power state of the image forming apparatus 1 to the second power saving state illustrated in FIG. 2E by powering on the general image processing unit power 27 and the printer unit power 28, and then finishes the processing. This is because since the USB storage is not writable, a scanned product cannot be stored, so that the likelihood of the scan function usage is low.

In addition, if it is determined that the USB storage is neither readable nor writable, the CPU 13 finishes this processing without performing power-on and the like.

FIG. 11 is a flowchart illustrating a method for controlling the image forming apparatus according to the present exemplary embodiment. This is an example of determination processing performed on the USB storage that is executed upon recognition that the external storage device 33 is connected via the external storage device I/F 32 illustrated in FIG. 1. Each step is realized by the CPU executing a control program stored in the HDD 14. Further, FIG. 11A illustrates a determination processing example whether the USB storage is readable, and FIG. 11B illustrates a determination processing example whether the USB storage is writable.

First, when performing the readability determination processing illustrated in FIG. 11A, in step S1101, the CPU 13 determines whether a USB storage is mounted. If it is determined that a USB storage is not mounted (NO in step S1101), in step S1104, the CPU 13 makes a “not readable” determination, and then finishes the processing.

On the other hand, if it is determined in step S1101 that a USB storage is mounted (YES in step S1101), in step S1102, the CPU 13 determines whether a readable file is present in the USB storage. If it is determined that a readable file is not present (NO in step S1102), in step S1104, the CPU 13 makes a “not readable” determination, and then finishes the processing.

If it is determined in step S1102 that a readable file is present (YES in step S1102), in step S1103, the CPU 13 determines that the USB storage is readable, and then finishes the processing.

When performing the USB storage writability determination processing illustrated in FIG. 11B, in step S1151, the CPU 13 determines whether the USB storage is write-protected (writing is prohibited) or not. If it is determined that the USB storage is write-protected (NO in step S1151), the processing proceeds to step S1156. In step S1156, the CPU 13 determines that the USB storage cannot be written onto, and finishes the processing.

On the other hand, if it is determined by the CPU in step S1151 that the USB storage is not write-protected (YES in step S1151), in step S1152, the CPU 13 determines whether a writable USB storage is mounted. If it is determined by the CPU 13 that a writable USB storage is not mounted (NO in step S1152), the processing proceeds to step S1156. In step S1156, the CPU 13 determines that data cannot be written onto the USB storage, and finishes the processing.

If it is determined in step S1152 that a writable USB storage is mounted (YES in step S1152), in step S1153, the CPU 13 determines whether there is enough space for writing the data in the USB storage. If it is determined that there is not enough space for writing the data in the USB storage (NO in step S1153), the processing proceeds to step S1156. In step S1156, the CPU 13 determines that the data cannot be written onto the USB storage, and finishes the processing.

On the other hand, if it is determined in step S1153 that there is enough space for writing the data in the USB storage (YES in step S1153), in step S1154, the CPU 13 determines whether a data writing test was successful. If it is determined that the data writing test was not successful (NO in step S1154), the processing proceeds to step S1156. In step S1156, the CPU 13 determines that the data cannot be written onto the USB storage, and finishes the processing. If it is determined in step S1154 that the data writing test was successful (YES in step S1154), in step S1155, the CPU 13 determines that the USB storage is writable, and finishes the processing.

The “write-protected” mentioned in step S1151 refers to a state in which a switch, which is referred to as an “accidental erasure prevention switch”, for example, provided on a side or rear face of the USB storage body is turned ON. For example, for a SD card, the accidental erasure prevention switch is arranged on the left side of the surface of the card. For a memory stick, the accidental erasure prevention switch is arranged in the center of the rear face of the stick.

In the first to fifth exemplary embodiments, the USB storage is newly connected during the standby illustrated in FIG. 2C. However, these exemplary embodiments can be applied even to the sleep state illustrated in FIG. 2B if a determination whether the USB storage was newly connected can be made by hardware.

Further, as the processing performed when the USB storage is connected, any of the power states in FIG. 2 to which the processing transitions to can also be set by the user (e.g., set with the operation unit 8).

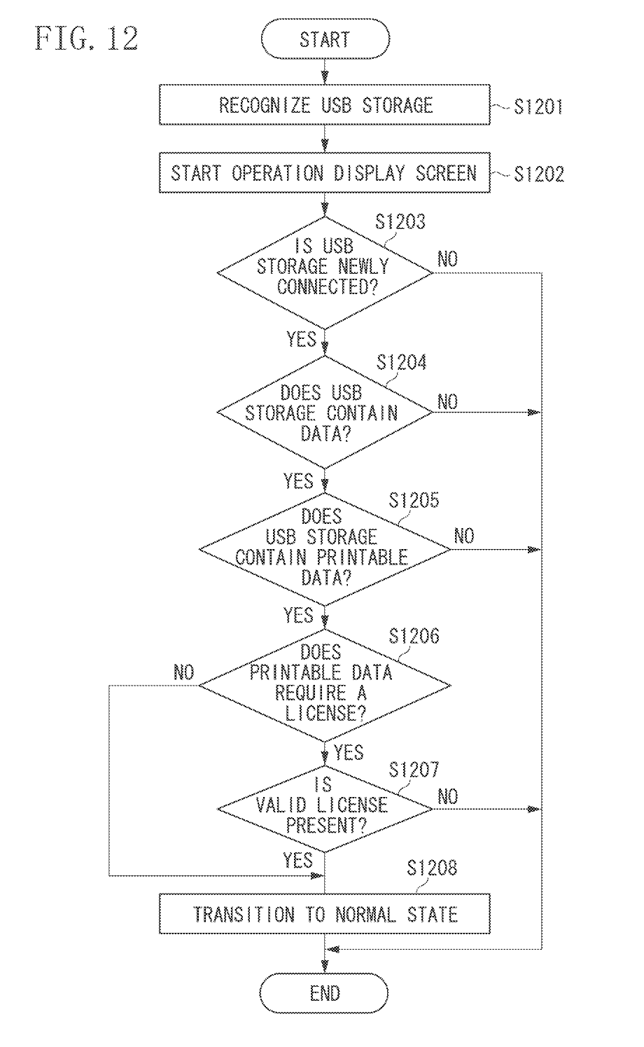

FIG. 12 is a flowchart illustrating a method for controlling the image forming apparatus according to a sixth exemplary embodiment. This example is a power control example executed upon recognition that the external storage device 33 has been connected to the external storage device I/F 32 illustrated in FIG. 1. Each step is realized by the CPU 13 executing a control program stored in the HDD 14.

In the present exemplary embodiment, similar to the first exemplary embodiment, the external storage device 33 is a USB storage. As described above, in the sleep state illustrated in FIG. 2B, the USB storage cannot be recognized. Therefore, the power state of the image forming apparatus 1 at the start of the flowchart is the standby state illustrated in FIG. 2C.

When the power state of the image forming apparatus 1 is in the standby state illustrated in FIG. 2C, in step S1201, the CPU 13 recognizes that a USB storage is connected via the external storage device I/F 32, and the processing proceeds to step S1202. In step S1202, the CPU 13 turns on the operation display screen of the operation unit 8 so that the image forming apparatus 1 can be operated by the user, and the processing then proceeds to step S1203.

In step S1203, the CPU 13 determines whether the connected USB storage was newly connected in the standby state of the image forming apparatus 1 illustrated in FIG. 2C. If it is determined by the CPU 13 that the USB storage was newly connected, a connect signal is input to the CPU 13 from the external storage device I/F 32. Consequently, if a connect signal has been input, the CPU 13 can determine that the USB storage is newly connected, and if a connect signal has not been input, the CPU 13 can determine that the connection state has not changed (i.e., the USB storage is not newly connected).

If it is determined by the CPU 13 that the USB storage is newly connected (YES in step S1203), the processing proceeds to step S1204, and if it is determined that the USB storage is not newly connected (NO in step S1203), the CPU 13 finishes this processing without performing power-on and the like.

In step S1204, the CPU 13 performs data detection processing on the USB storage via the external storage device I/F 32. Specifically, the CPU 13 determines whether data is detected in the USB storage. If it is determined by the CPU 13 that the data is detected in the USB storage (YES in step S1204), the processing proceeds to step S1205. If it is determined by the CPU 13 that the data cannot be detected (NO in step S1204), the CPU 13 finishes this processing without performing power-on and the like. In step S1205, the CPU 13 determines whether it has detected the data in the USB storage that can be printed by the image forming apparatus 1. If it is determined by the CPU 13 that printable data has not been detected (NO in step S1205), the CPU 13 finishes this processing without performing power-on and the like.

On the other hand, if the CPU 13 determines in step S1205 that it has detected the data that can be printed by the image forming apparatus 1 (YES in step S1205), the processing proceeds to step S1206.

In step S1206, the CPU 13 determines whether a license (authorization) is required (an authorization state) to perform identification processing of the data in the USB storage that can be printed by the image forming apparatus 1.

This is performed because the image forming apparatus 1 includes partially-limited functions. Accordingly, by validating the license for a partially-limited function, the user can use that function. If it is determined by the CPU 13 that the license for a partially-limited function is valid in the image forming apparatus 1, for example, the CPU 13 raises a license flag that validates the license of that function in a non-volatile storage device, such as the HDD 14. The CPU 13 accesses the HDD 14, and if the license flag has been raised, determines that this function can be used, and the processing proceeds to the next step.

If it is determined by the CPU 13 that a license is required to process the printable data (YES in step S1206), the processing proceeds to step S1207. If it is determined that a license is not required (NO in step S1206), the processing proceeds to step S1208. In step S1208, the CPU 13 transitions the power state of the image forming apparatus 1 to the normal state illustrated in FIG. 2A by powering on the scanner unit power 26, the general image processing unit power 27, and the printer unit power 28, which correspond to the processing units specified from the license.

In step S1207, the CPU 13 further determines whether the license for processing the printable data is valid in the image forming apparatus 1. If it is determined that the license for processing the printable data is valid (YES in step S1207), the processing proceeds to step S1208. In step S1208, the CPU 13 transitions the power state of the image forming apparatus 1 to the normal state illustrated in FIG. 2A by powering on the scanner unit power 26, the general image processing unit power 27, and the printer unit power 28, and then finishes the processing.

On the other hand, if it is determined in step S1207 by the CPU 13 that the license is not valid (NO in step S1207), the CPU 13 finishes this processing without performing power-on and the like.

Consequently, for example, in FIG. 5, if the license is valid, data such as the doc/xls data can be processed by the image forming apparatus 1. In such a state, when the user connects a USB storage to the external storage device I/F 32 of the image forming apparatus 1, if there is only data such as doc/xls data in the USB storage, unless the license for processing doc/xls data is valid in the image forming apparatus 1, printing from the USB storage cannot be executed. Consequently, in the present exemplary embodiment, since the printer apparatus 4 is not powered on, power consumption can be suppressed. Further, if the license for processing doc/xls data is valid in the image forming apparatus 1, the user can execute printing from the USB storage.

Consequently, if there is printable data, the printer apparatus 4 is powered on. Accordingly, the temperature of the fixing unit in the printer apparatus 4 can be raised in advance, so that the print job can be executed efficiently.

If data that requires a license and also data that does not require a license are present in the USB storage, if the detected data is printable, the printer apparatus 4 may be powered on like in the first exemplary embodiment. Further, the sixth exemplary embodiment is applied not only when a USB storage is connected, but the sixth exemplary embodiment can also be applied to the data that has been transmitted via the LAN 9 from the computer 10.

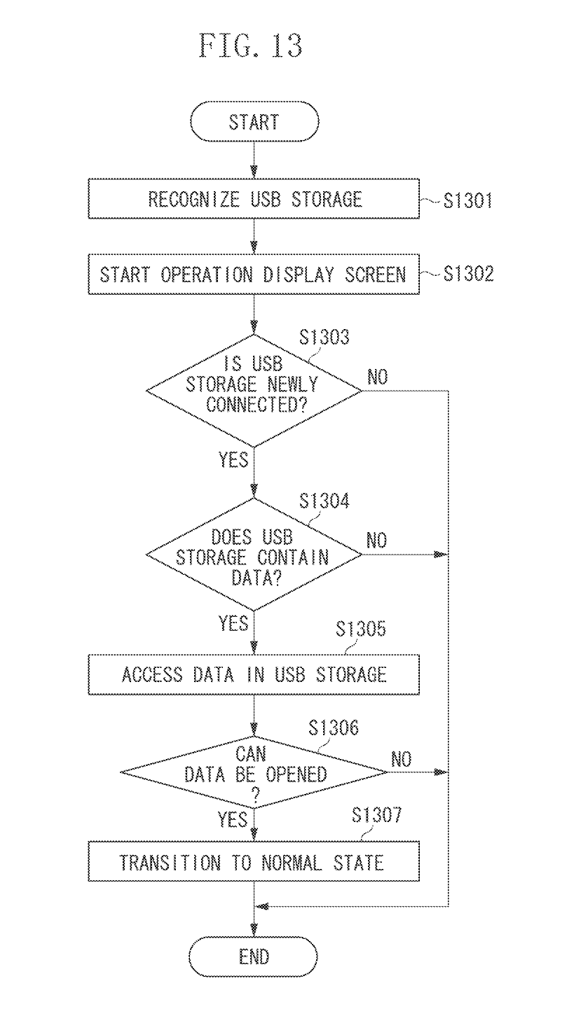

FIG. 13 is a flowchart illustrating a method for controlling the image forming apparatus according to a seventh exemplary embodiment. This example is a power control example executed upon recognition that the external storage device 33 has been connected to the external storage device I/F 32 illustrated in FIG. 1. Each step is realized by the CPU 13 executing a control program stored in the HDD 14.

In the present exemplary embodiment, similar to the first exemplary embodiment, the external storage device 33 is a USB storage. As described above, in the sleep state illustrated in FIG. 2B, the USB storage cannot be recognized. Therefore, the power state of the image forming apparatus 1 at the start of the flowchart is the standby state illustrated in FIG. 2C.

When the power state of the image forming apparatus 1 is in the standby state illustrated in FIG. 2C, in step S1301, the CPU 13 recognizes that a USB storage is connected via the external storage device I/F 32, and the processing proceeds to step S1302. In step 1302, the CPU 13 turns on the operation display screen of the operation unit 8 so that the image forming apparatus 1 can be operated by the user, and the processing then proceeds to step S1303.

In step S1303, the CPU 13 determines whether the USB storage being connected was newly connected in the standby state of the image forming apparatus 1 illustrated in FIG. 2C. If the USB storage was newly connected, a connect signal is input to the CPU 13 from the external storage device I/F 32. Consequently, if a connect signal has been input, the CPU 13 can determine that the USB storage is newly connected, and if a connect signal has not been issued, the CPU 13 can determine that the connection state has not changed (i.e., the USB storage is not newly connected).

If it is determined by the CPU 13 that the USB storage is newly connected (YES in step S1303), the processing proceeds to step S1304. If it is determined that the USB storage is not newly connected (NO in step S1303), the CPU 13 finishes this processing without performing power-on and the like.

In step S1304, the CPU 13 performs data detection processing on the USB storage via the external storage device I/F 32. Specifically, the CPU 13 determines whether the data is detected in the USB storage. If it is determined by the CPU 13 that the data is detected in the USB storage (YES in step S1304), the processing proceeds to step S1305. If it is determined by the CPU 13 that the data cannot be detected (NO in step S1304), the CPU 13 finishes this processing without performing power-on and the like.

In step S1305, the CPU 13 accesses the data detected in step S1304, and tries to open the data. In step S1306, the CPU 13 determines whether the data in the USB storage that it accessed can be opened. If it is determined by the CPU 13 that the data can be opened (YES in step S1306), the processing proceeds to step S1307. If it is determined by the CPU 13 that the data cannot be opened (NO in step S1306), the CPU 13 finishes this processing without performing power-on and the like.

In step S1307, the CPU 13 transitions the power state of the image forming apparatus 1 to the normal state illustrated in FIG. 2A by powering on the scanner unit power 26, the general image processing unit power 27, and the printer unit power 28, which are identified based on whether the data can be opened.

If the data cannot be opened, it is conceivable that the data is protected with a password, is encrypted, or is a non-convertible image, for example. If none of the data in the USB storage can be opened, this means that there is no data in the USB storage that can be printed by the image forming apparatus 1, so that the printer apparatus 4 is not powered on. Accordingly, in the present exemplary embodiment, power consumption can be suppressed. Further, if even one piece of data in the USB storage can be opened, the printer apparatus 4 is powered on. This enables the temperature of the fixing unit in the printer apparatus 4 to rise in advance, so that the print job can be executed efficiently.

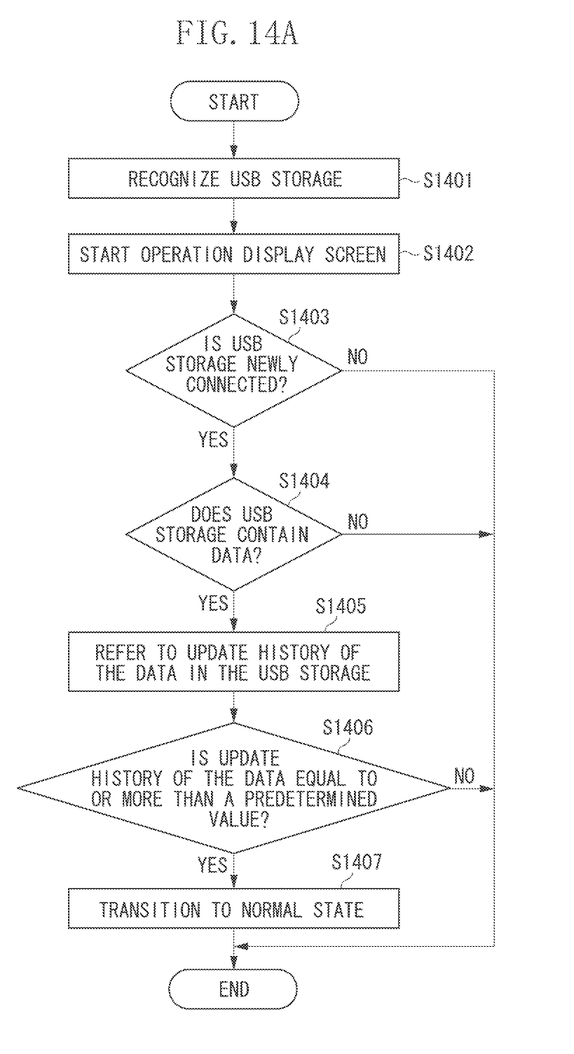

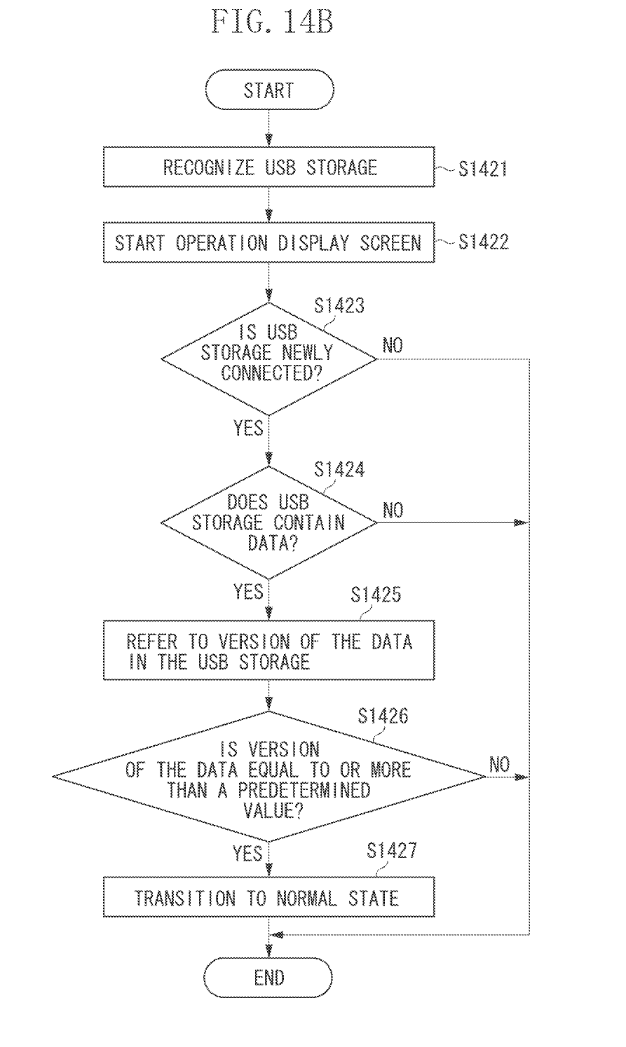

FIGS. 14A and 14B are flowcharts illustrating a method for controlling the image forming apparatus according to an eighth exemplary embodiment. This example is a power control example executed upon recognition that the external storage device 33 has been connected to the external storage device I/F 32 illustrated in FIG. 1. Each step is realized by the CPU 13 executing a control program stored in the HDD 14. FIG. 14A is an example of controlling the power-on processing by determining an update history state (number of updates) of data stored in the USB storage. FIG. 14B is an example of controlling the power-on processing by determining version information added to the data stored in the USB storage.

In the present exemplary embodiment, similar to the first exemplary embodiment, the external storage device 33 is a USB storage. As described above, in the sleep state illustrated in FIG. 2B, the USB storage cannot be recognized. Therefore, the power state of the image forming apparatus 1 at the start of the flowchart is the standby state illustrated in FIG. 2C.

When the power state of the image forming apparatus 1 is in the standby state illustrated in FIG. 2C, in step S1401, the CPU 13 recognizes that a USB storage is connected via the external storage device I/F 32, and the processing proceeds to step S1402. In step S1402, the CPU 13 turns on the operation display screen of the operation unit 8 so that the image forming apparatus 1 can be operated by the user, and the processing then proceeds to step S1403.

In step S1403, the CPU 13 determines whether the connected USB storage was newly connected in the standby state of the image forming apparatus 1 illustrated in FIG. 2C. If the USB storage was newly connected, a connect signal is input to the CPU 13 from the external storage device I/F 32. Consequently, if a connect signal has been input, the CPU 13 can determine that the USB storage is newly connected, and if a connect signal has not been issued, the CPU 13 can determine that the connection state has not changed (i.e., the USB storage is not newly connected).

If it is determined by the CPU 13 that the USB storage is newly connected (YES in step S1403), the processing proceeds to step S1404. If it is determined that the USB storage is not newly connected (NO in step S1403), the CPU 13 finishes this processing without performing power-on and the like.

In step S1404, the CPU 13 performs data detection processing on the USB storage via the external storage device I/F 32. Specifically, the CPU 13 determines whether the data is detected in the USB storage. If it is determined by the CPU 13 that the data is detected in the USB storage (YES in step S1404), the processing proceeds to step S1405. If it is determined by the CPU 13 that the data cannot be detected (NO in step S1404), the CPU 13 finishes this processing without performing power-on and the like.

In step S1405, the CPU 13 accesses the data detected in step S1404, refers to the update history of the data, and the processing then proceeds to step S1406. In step S1406, the CPU 13 determines whether the update history of the accessed data in the USB storage is equal to or more than a predetermined value. If it is determined by the CPU 13 that the update history is equal to or more than the predetermined value (YES in step S1406), the processing proceeds to step S1407. If it is determined by the CPU 13 that the update history is not equal to or more than the predetermined value (NO in step S1406), the CPU 13 finishes this processing without performing power-on and the like.

In step S1407, the CPU 13 transitions the power state of the image forming apparatus 1 to the normal state illustrated in FIG. 2A by powering on the scanner unit power 26, the general image processing unit power 27, and the printer unit power 28, which are identified from the update history (number of updates).

In the present exemplary embodiment, the predetermined value of the data update history is set as year-month-day data. The predetermined value is set when the apparatus is shipped from the factory, or may be changed by the user with the operation unit 8, the computer 10 and the like. Further, if none of the update histories in the USB storage are equal to or more than the predetermined value, this means there is no data in the USB storage that needs to be printed, and the printer apparatus 4 is not powered on.

In FIG. 14B, since the processing from steps S1421 to S1424 is the same as steps S1401 to 1404, a description thereof will be omitted here.

In step S1425, the CPU 13 accesses the data detected in step S1424, then refers to the version of the data, and the processing proceeds to step S1426. In step S1426, the CPU 13 determines whether the version of the accessed data in the USB storage is equal to or more than a predetermined value. If it is determined by the CPU 13 that the version is equal to or more than the predetermined value (YES in step S1426), the processing proceeds to step S1427. If it is determined that the version is not equal to or more than the predetermined value (NO in step S1426), the CPU 13 finishes this processing without performing power-on and the like.

In step S1427, the CPU 13 transitions the power state of the image forming apparatus 1 to the normal state illustrated in FIG. 2A by powering on the scanner unit power 26, the general image processing unit power 27, and the printer unit power 28, which are identified from the version.

In the present exemplary embodiment, the predetermined value of the data version can change when, for example, the version of document creation software is incorporated in the text data, or the extension file changes based on the used document creation software. Similar to the predetermined value of the update history, the predetermined value of the version can be set when the apparatus is shipped from the factory, or can be changed by the user with the operation unit 8, the computer 10 and the like. Further, if none of the update version data in the USB storage is equal to or more than the predetermined value, this means there is no data in the USB storage that needs to be printed and the printer apparatus 4 is not powered on. Accordingly, in the present exemplary embodiment, power consumption can be suppressed.

If even one update history or version of the data in the USB storage is equal to or more than the predetermined value, the printer apparatus 4 is powered on. This enables the temperature of the fixing unit in the printer apparatus 4 to rise in advance, so that the print job can be executed efficiently.

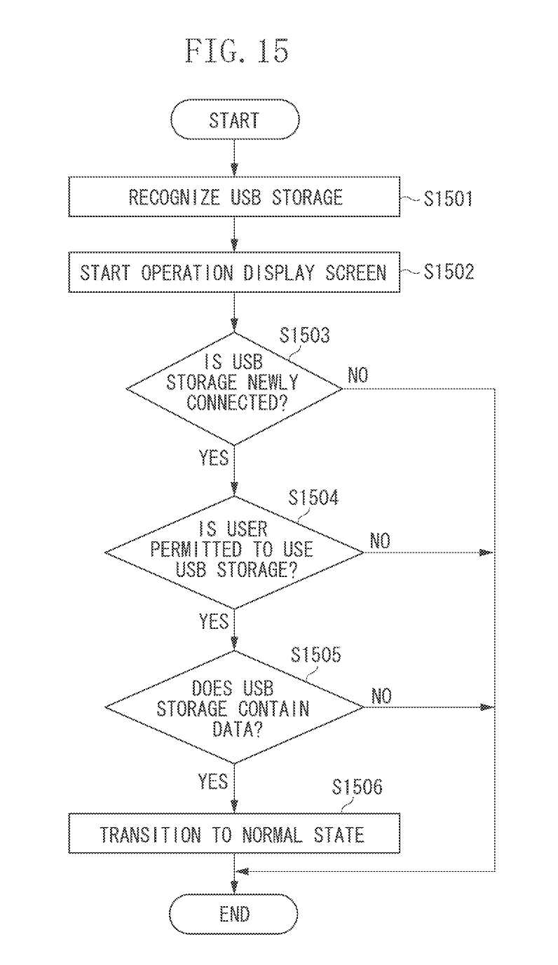

FIG. 15 is a flowchart illustrating a method for controlling the image forming apparatus according to a ninth exemplary embodiment. This example is a power control example executed upon recognition that the external storage device 33 has been connected to the external storage device I/F 32 illustrated in FIG. 1. Each step is realized by the CPU 13 executing a control program stored in the HDD 14.

In the present exemplary embodiment, similar to the first exemplary embodiment, the external storage device 33 is a USB storage. As described above, since the USB storage cannot be recognized in the sleep state illustrated in FIG. 2B, the power state of the image forming apparatus at the start of the flowchart is the standby state illustrated in FIG. 2C.

When the power state of the image forming apparatus 1 is in the standby state illustrated in FIG. 2C, in step S1501, the CPU 13 recognizes that a USB storage is connected via the external storage device I/F 32, and the processing proceeds to step S1502. In step S1502, the CPU 13 turns on the operation display screen of the operation unit 8 so that the image forming apparatus 1 can be operated by the user, and the processing then proceeds to step S1503.

In step S1503, the CPU 13 determines whether the USB storage being connected was newly connected in the standby state of the image forming apparatus 1 illustrated in FIG. 2C. If the USB storage was newly connected, a connect signal is input to the CPU 13 from the external storage device I/F 32. Consequently, if a connect signal has been input, the CPU 13 can determine that the USB storage is newly connected, and if a connect signal has not been issued, the CPU 13 can determine that the connection state has not changed (i.e., the USB storage is not newly connected).

If it is determined by the CPU 13 that the USB storage is newly connected (YES in step S1503), the processing proceeds to step S1504 If it is determined that the USB storage is not newly connected (NO in step S1503), the CPU 13 finishes this processing without performing power-on and the like.

In step S1504, the CPU 13 determines whether the user using the image forming apparatus 1 is a user who is permitted to use the USB storage, namely, a user who can utilize stored data. If it is determined by the CPU 13 that the user is permitted to use the USB storage (YES in step S1504), the processing proceeds to step S1505. If it is determined by the CPU 13 that the user is not permitted to use the USB storage (NO in step S1504), the CPU 13 finishes this processing without performing power-on and the like.

This user authentication is performed by a user authentication program in a non-volatile storage device, such as the HDD 14, in the image forming apparatus 1, or by an external device via an I/F connected with the external device, such as the LAN 9.

In step S1505, the CPU 13 determines via the external storage device I/F 32 whether data is in the USB storage based on a specified user. If it is determined by the CPU 13 that there is the data in the USB storage (YES in step S1505), the processing proceeds to step S1506. If it is determined by the CPU 13 that there is no data in the USB storage (NO in step S1505), the CPU 13 finishes this processing without performing power-on and the like.

In step S1506, the CPU 13 performs control to transition the power state of the image forming apparatus 1 to the normal state illustrated in FIG. 2A by powering on the scanner unit power 26, the general image processing unit power 27, and the printer unit power 28. Then, the processing performed in this flowchart is finished.

In step S1505, if the CPU 13 could not detect data in the USB storage, it is conceivable that the user is going to store scanned data in the USB storage. In this case, in step S1505, the CPU 13 may perform control so that the power state of the image forming apparatus 1 transitions to the first power saving state illustrated in FIG. 2D by powering on the scanner unit power 26 and general image processing unit power 27.

For example, for a workplace in which only employees who are at management level or higher are permitted to use USB storage, a determination is made whether the user currently using the image forming apparatus is a management level employee or higher with the user authentication function. If it is determined that the user is a management level employee or higher, the processing proceeds to the determination about whether to power on the printer apparatus 4 based on the determination about data in the USB storage. Consequently, in the ninth exemplary embodiment, even if a user who is not permitted to use USB storage connects a USB storage to the image forming apparatus, since the printer apparatus 4 is not powered on, power consumption can be suppressed. Further, in the first to ninth exemplary embodiments, the USB storage was newly connected in the standby state illustrated in FIG. 2C. However, these exemplary embodiments can be applied even in the sleep state illustrated in FIG. 2B if a determination whether the USB storage was newly connected can be made by hardware.

Further, as the processing performed when the USB storage is connected, any of the power states in FIG. 2 to which the processing transitions to may also be set by the user (e.g., set with the operation unit 8).

The above first to ninth exemplary embodiments may be combined in an organic and integrated manner to realize reductions in power consumption during USB storage connection.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-018393 filed Feb. 1, 2013, which is hereby incorporated by reference herein in its entirety.

What is claimed is:

1. An image forming apparatus comprising:
a plurality of processing units configured to perform predetermined image processing;
a connection unit configured to connect to an external storage unit;
an identification unit configured to, in response to the connection of the external storage unit, identify information stored in the external storage unit;
a specification unit configured to specify processing units to supply power to among the plurality of processing units based on the identified information; and
a control unit configured to supply power to the specified processing units.

2. An image forming apparatus comprising:
a plurality of processing units configured to perform predetermined image processing;
a connection unit configured to connect to an external storage unit;
an identification unit configured to, in response to the connection of the external storage unit, identify a read/write state of data in the external storage unit;
a specification unit configured to specify processing units to supply power to among the plurality of processing units based on the identified read/write state; and
a control unit configured to supply power to the specified processing units.

3. An image forming apparatus comprising:
a plurality of processing units configured to perform predetermined image processing;
a connection unit configured to connect to an external storage unit;
an identification unit configured to, in response to the connection of the external storage unit, identify an authorization state of data stored in the external storage unit;
a specification unit configured to specify processing units to supply power to among the plurality of processing units based on the identified authorization state; and
a control unit configured to supply power to the specified processing units.

4. An image forming apparatus comprising:
a plurality of processing units configured to perform predetermined image processing;
a connection unit configured to connect to an external storage unit;
an identification unit configured to, in response to the connection of the external storage unit, identify a number of updates of data stored in the external storage unit;
a specification unit configured to specify processing units to supply power to among the plurality of processing units based on the identified number of updates; and
a control unit configured to supply power to the specified processing units.

5. An image forming apparatus comprising:
a plurality of processing units configured to perform predetermined image processing;
a connection unit configured to connect an external storage unit;
an identification unit configured to, in response to the external storage unit being connected, identify version information added to data stored in the external storage unit;
a specification unit configured to specify processing units to supply power to among the plurality of processing units based on the identified version information; and
a control unit configured to supply power to the specified processing units.

6. An image forming apparatus comprising:
a plurality of processing units configured to perform predetermined image processing;
a connection unit configured to connect to an external storage unit;
an identification unit configured to, in response to the connection of the external storage unit, identify a user who can utilize data stored in the external storage unit;
a specification unit configured to specify processing units to supply power to among the plurality of processing units based on the identified user; and
a control unit configured to supply power to the specified processing units.

7. An image forming apparatus comprising:
a plurality of processing units configured to perform predetermined image processing;
a connection unit configured to connect to an external storage unit;
an identification unit configured to, in response to the connection of the external storage unit, identify data stored in the external storage unit which can be opened;
a specification unit configured to specify processing units to supply power to among the plurality of processing units if the data is identified as openable data; and
a control unit configured to supply power to the specified processing units.

8. The image forming apparatus according to claim 1, wherein the processing units include a printing unit, a reading unit, an image processing unit, and a printing unit, a reading unit, and a control unit configured to control the image processing unit.

9. The image forming apparatus according to claim 1, wherein the information stored in the external storage unit is print data, power supply instruction data, and control text data.

10. The image forming apparatus according to claim 2, wherein the identification unit is configured to identify a state in which data cannot be written, when a write limitation of data is set to the external storage unit, when there is not enough space to write data in the external storage unit, and when the external storage unit cannot be recognized.

11. The image forming apparatus according to claim 2, wherein the identification unit is configured to identify a state in which data cannot be read when the external storage unit cannot be recognized.

12. The image forming apparatus according to claim 2, wherein the control unit is configured to perform control so that power is not supplied to the printing unit among the processing units when data cannot be read from the external storage unit but data can be written.

13. The image forming apparatus according to claim 2, wherein the control unit is configured to control so that power is not supplied to the reading unit among the processing units when data can be read from the external storage unit but data cannot be written.

14. The image forming apparatus according to claim 2, wherein the control unit is configured to perform control so that power is not supplied to the printing unit or the reading unit among the processing units when data cannot be read from the external storage unit and data cannot be written.

15. A method for controlling an image forming apparatus that comprises a plurality of processing units configured to perform predetermined image processing and a connection unit configured to connect to an external storage unit, the method comprising:
identifying, in response to the connection to the external storage unit, information stored in the external storage unit;
specifying processing units to supply power to among the plurality of processing units based on the identified information; and
supplying power to the specified processing units.

16. A method for controlling an image forming apparatus that comprises a plurality of processing units configured to perform predetermined image processing and a connection unit configured to connect to an external storage unit, the method comprising:
identifying, in response to the connection of the external storage unit, a read/write state of data in the external storage unit;
specifying processing units to supply power to among the plurality of processing units based on the identified read/write state; and
performing control to supply power to the specified processing units.

17. A method for controlling an image forming apparatus that comprises a plurality of processing units configured to perform predetermined image processing and a connection unit configured to connect to an external storage unit, the method comprising:
identifying, in response to the connection of the external storage unit, an authorization state of data stored in the external storage unit;
specifying processing units to supply power to among the plurality of processing units based on the identified authorization state; and
performing control to supply power to the specified processing units.

18. A method for controlling an image forming apparatus that comprises a plurality of processing units configured to perform predetermined image processing and a connection unit configured to connect to an external storage unit, the method comprising:
identifying, in response to the connection of the external storage unit, a number of updates of data stored in the external storage unit;
specifying processing units to supply power to among the plurality of processing units based on the identified number of updates; and
performing control to supply power to the specified processing units.

19. A method for controlling an image forming apparatus that comprises a plurality of processing units configured to perform predetermined image processing and a connection unit configured to connect to an external storage unit, the method comprising:
identifying, in response to the connection of the external storage unit, version information added to data stored in the external storage unit;
specifying processing units to supply power to among the plurality of processing units based on the identified version information; and
performing control to supply power to the specified processing units.

20. A method for controlling an image forming apparatus that comprises a plurality of processing units configured to perform predetermined image processing and a connection unit configured to connect to an external storage unit, the method comprising:
identifying, in response to the connection of the external storage unit, a user who can utilize data stored in the external storage unit;
specifying processing units to supply power to among the plurality of processing units based on the identified user; and
performing control to supply power to the specified processing units.

21. A method for controlling an image forming apparatus that comprises a plurality of processing units configured to perform predetermined image processing and a connection unit configured to connect to an external storage unit, the method comprising:
identifying, in response to the connection of the external storage unit, the data stored in the external storage unit which can be opened;
specifying processing units to supply power to among the plurality of processing units if the data is identified as openable; and
performing control to supply power to the specified processing units.

22. A computer-readable storage medium that stores a program capable of causing a computer to execute the method for controlling an image forming apparatus according to claim 15.
